(19) United States
(12) Patent Application Publication
(10) Pub. No.: US 2025/0184965 A1
(43) Pub. Date: Jun. 5, 2025

(54) TRANSMISSION METHOD, USER EQUIPMENT, MANAGEMENT ENTITY, AND STORAGE MEDIUM

(71) Applicant: ZTE CORPORATION, Shenzhen (CN)

(72) Inventors: Ting MIAO, Shenzhen (CN); Weimin XING, Shenzhen (CN); Youxiong LU, Shenzhen (CN); Feng BI, Shenzhen (CN); Haigang HE, Shenzhen (CN); Jie CHEN, Shenzhen (CN); Yuzhou HU, Shenzhen (CN)

(21) Appl. No.: 18/844,245

(22) PCT Filed: Apr. 24, 2023
(86) PCT No.: PCT/CN2023/090191

§ 371 Date: Sep. 5, 2024

(30) Foreign Application Priority Data
Apr. 26, 2022 (CN) 202210451889.X

(51) Int. Cl. H04W 72/02; H04W 72/542

(52) U.S. Cl. CPC H04W 72/02; H04W 72/542

(57) ABSTRACT

Provided are a transmission method, a user equipment, a management entity, and a storage medium. The method includes the following: To-be-transmitted information is determined, where the to-be-transmitted information indicates that a management entity selects a resource for the user equipment; and the to-be-transmitted information is transmitted to the management entity.

This application claims priority to Chinese Patent Application No. 202210451889. X filed with the China National Intellectual Property Administration (CNIPA) on Apr. 26, 2022, the disclosure of which is incorporated herein by reference in its entirety.

### TECHNICAL FIELD

The present application relates to the field of communication technology, for example, a transmission method, a user equipment, a management entity, and a storage medium.

### BACKGROUND

Direct communication may also be referred to as sidelink (SL) communication. There are currently two radio access technologies (RATs) for SL communication. Two modes exist to allocate SL resources. One is that a base station allocates SL transmission resources to user equipments (UEs); the other is that the user equipment autonomously selects SL transmission resources.

In current SL communication, it is generally believed that the devices of the two RATs work on different carriers or channels. However, there may not be enough spectrums for different RATs. Therefore, how to make SL communication coexist in the same frequency resource to avoid interference caused by resource coexistence is a technical problem that needs to be solved urgently.

### SUMMARY

The present application provides a transmission method, a user equipment, a management entity, and a storage medium.

Embodiments of the present application provide a transmission method. The method is applied to a user equipment and includes the following: To-be-transmitted information is determined, where the to-be-transmitted information indicates that a management entity selects a resource for the user equipment; and the to-be-transmitted information is transmitted to the management entity.

Embodiments of the present application also provide a transmission method. The method is applied to a management entity and includes the following: To-be-transmitted information is acquired, where the to-be-transmitted information indicates that the management entity selects a resource for a user equipment; and the resource is selected based on the to-be-transmitted information.

Embodiments of the present application also provide a user equipment. The equipment includes a memory, a processor, and a computer program stored in the memory and executable by the processor. When executing the computer program, the processor performs the preceding transmission method.

Embodiments of the present application also provide a management entity. The entity includes a memory, a processor, and a computer program stored in the memory and executable by the processor. When executing the computer program, the processor performs the preceding transmission method.

Embodiments of the present application also provide a storage medium. The storage medium stores a computer program that, when executed by a processor, causes the processor to perform the preceding transmission method.

The preceding embodiments and other aspects of the present application and implementations thereof are described in more detail in the brief description of drawings, detailed implementations, and claims.

### BRIEF DESCRIPTION OF DRAWINGS

FIG. 1 is a flowchart of a transmission method according to an embodiment.

FIG. 2 is a flowchart of another transmission method according to an embodiment.

FIG. 3 is a diagram illustrating the structure of a transmission apparatus according to an embodiment.

FIG. 4 is a diagram illustrating the structure of a transmission apparatus according to an embodiment.

FIG. 5 is a diagram illustrating the hardware structure of a user equipment according to an embodiment.

FIG. 6 is a diagram illustrating the hardware structure of a management entity according to an embodiment.

### DETAILED DESCRIPTION

To illustrate the object, solutions, and advantages of the present application more clearly, embodiments of the present application are described hereinafter in detail in conjunction with drawings. It is to be noted that if not in collision, embodiments of the present application and features therein may be combined with each other in any manner.

Procedures illustrated in flowcharts among the drawings may be executed by, for example, a computer system capable of executing a set of computer-executable instructions. Moreover, although logical sequences are illustrated in the flowcharts, the procedures illustrated or described may be performed in sequences different from those described herein in some cases.

Direct communication may also be referred to as SL communication. Subsequently, SL communication may refer to all direct communications. SL communication currently has two types of radio access technologies (RATs), that is, SL communication using the fourth-generation mobile communication technology (4G) Long-Term Evolution (LTE) technology and SL communication using the fifth-generation mobile communication technology (5G) New Radio (NR) technology. Two modes exist to allocate SL resources. One is that a base station allocates an SL transmission resource to UE; the mode is referred to as mode 1 in NR SL and mode 3 in LTE SL. The other mode for allocation is that a user equipment (that is, UE) autonomously selects an SL transmission resource; the mode is referred to as mode 2 in NR SL and mode 4 in LTE SL. Currently, SL communication does not consider the sharing of spectrum by two different resource allocation modes of NR SL nor the scenario where two RATs share the spectrum. That is, it is generally believed that the devices of the two RATs work on different carriers or channels, and in this case, there may not be enough spectrums for the different RATs. Thus, the coexistence of SL communication with different RATs or different resource allocation modes has become an urgent need. To enable SL communication with different RATs or SL communication with different resource allocation modes to coexist in the same frequency resource, a mechanism is needed to effectively utilize resources without negatively affecting the operation of SL communication with different RATs or SL communication with different resource allocation modes and to avoid interference caused by resource coexistence.

In the embodiments, the configuration generally comes from a network or a base station and is sent from the network or the base station to the UE by signaling; the pre-configuration is generally a configuration provided by another higher-layer entity, such as the higher layer of the UE itself or another network entity. In the present application, configuration and pre-configuration are not strictly distinguished, and the management entity refers to a base station, a network, or another higher-layer entity. The 4G access network is also referred to as Evolved Universal Terrestrial Radio Access (E-UTRA). The present application does not strictly distinguish between names such as 4G, LTE, EUTRA, and Evolved Universal Terrestrial Radio Access Network (E-UTRAN) or between names such as NR network and NR base station.

The present application is described for one resource pool, one bandwidth part (BWP), or one carrier. The method of the present application may be applied to a case of multiple resource pools, multiple BWPs, or multiple carriers. It is only necessary to provide and process information corresponding to each resource pool, each BWP, or each carrier separately.

The reference signal received power (RSRP) in the present application may also be any other parameter reflecting the signal received strength or received quality, such as reference signal received quality (RSRQ), signal-to-interference-plus-noise ratio (SINR), and received signal strength indicator (RSSI). It only needs to replace RSRP with a corresponding parameter.

The details of the NR perception process in the present application may not be specifically limited, and the details of the LTE perception process, LTE monitoring of LTE SL sidelink control information (SCI), or LTE resource reservation are not limited. In the present application, the process by which a management entity selects a sending resource for the UE is also applicable to selecting a receiving resource for the UE. That is, when a sending resource is selected for the UE, the resource set and conflict information are both for the sending resource of the UE; when a receiving resource is selected for the UE, the resource set and conflict information are both for the receiving resource of the UE.

In the present application, the management entity may be considered as a higher layer, and the management entity may include one of the following: a higher layer of the UE, a higher layer of a first module of the UE, a higher layer of a second module of the UE, an NR base station, or an NR network. Unless it is specifically stated that the higher layer is of a specific module (for example, the higher layer of the first module or the higher layer of the second module) or of the higher layer of the UE, generally, the higher layer includes a higher layer of the UE, an NR base station, or an NR network. When the higher layer is the NR base station or the NR network, the UE may first provide the determined information to the higher layer of the UE, the higher layer of the first module of the UE, or the higher layer of the second module of the UE, and then the higher layer of the UE, the higher layer of the first module of the UE, or the higher layer of the second module of the UE sends the determined information to the NR base station or the NR network, for example, by the higher-layer signaling. The physical layer of the UE, the physical layer of the first module of the UE, or the physical layer of the second module of the UE may also directly send the determined information to the NR base station or the NR network, for example, by a physical uplink control channel (PUCCH).

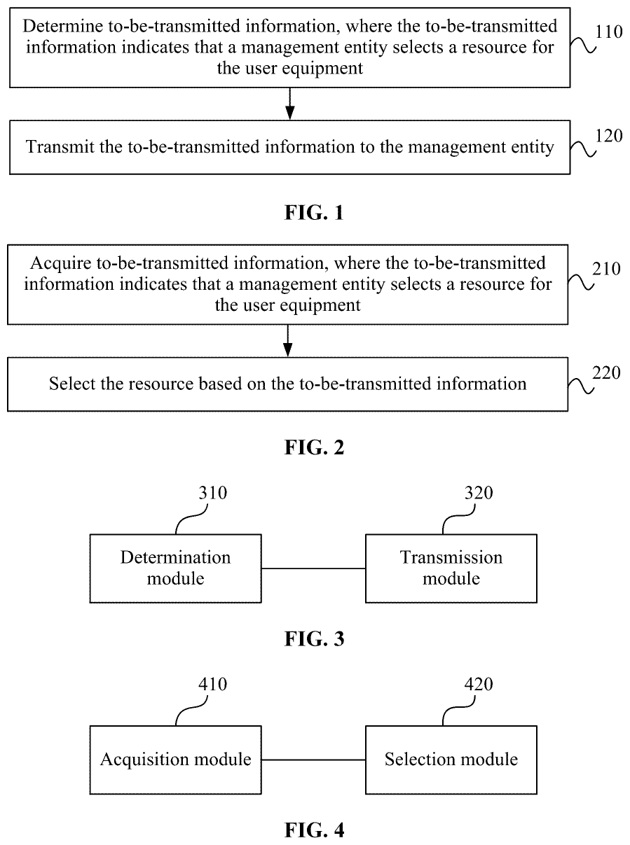

To resolve the preceding technical problem, FIG. 1 is a flowchart of a transmission method according to an embodiment. As shown in FIG. 1, the method provided in this embodiment may be applied to a user equipment (that is, UE) and includes S110 and S120.

In S110, to-be-transmitted information is determined, where the to-be-transmitted information indicates that a management entity selects a resource for the user equipment.

In this embodiment, the to-be-transmitted information may be understood as information waiting to be transmitted. The to-be-transmitted information may be used to indicate that a management entity selects a resource for the user equipment. The to-be-transmitted information is not specifically limited herein. For example, the to-be-transmitted information may include conflict information and/or a resource set. The conflict information may be used to indicate a conflict resource (i.e., a resource on which conflict exists) in allocated or reserved resources. The resource set may be understood as a set of resources for transmission. The resource set may include an NR candidate resource set, an NR unavailable resource set, and/or an available resource set.

How to determine the to-be-transmitted information is not specifically limited in this embodiment.

In S120, the to-be-transmitted information is transmitted to the management entity.

In this embodiment, the UE determines to-be-transmitted information and transmits the determined to-be-transmitted information to the management entity so that the management entity selects a resource for the UE according to the received to-be-transmitted information (it may also be understood as that an SL transmission resource is allocated to the UE).

The UE may include a first module and a second module. The first module may be an NR SL module of the UE. The second module may be an LTE SL module of the UE. Transmission of the to-be-transmitted information to the management entity is not specifically limited herein. For example, the UE may transmit the to-be-transmitted information to the management entity. Alternatively, the first module of the UE transmits the to-be-transmitted information to the management entity. Alternatively, the second module of the UE may transmit the to-be-transmitted information to the management entity. The to-be-transmitted information may include multiple types of information, and different information may be transmitted by at least one of the following: UE; a first module of the UE; or a second module of the UE.

In this embodiment, the UE side determines to-be-transmitted information and transmits the determined to-be-transmitted information to the management entity so that the management entity that receives the to-be-transmitted information can select, according to the to-be-transmitted information, an available SL transmission resource that does not have resource conflict for the UE. Thus, interference caused by resource coexistence can be avoided, and SL communication can coexist in the same frequency resource.

In an embodiment, the to-be-transmitted information includes conflict information, and the conflict information indicates a conflict resource in an allocated or reserved resource.

In this embodiment, the to-be-transmitted information may include conflict information, and the conflict information may be used to indicate a conflict resource in allocated or reserved resources.

In an embodiment, the to-be-transmitted information includes a resource set, and the resource set includes one or more of the following: an NR candidate resource set; an NR unavailable resource set, where the NR unavailable resource set is a set of resources that are reserved for SL of LTE or cannot be used by the user equipment for a capability reason; or an available resource set, where the available resource set is a candidate resource set acquired by the user equipment through an LTE perception process.

In this embodiment, the to-be-transmitted information may include a resource set. The resource set may include one or more of an NR candidate resource set, an NR unavailable resource set, and an available resource set. The resource set is not specifically limited herein. For example, the resource set may include an NR candidate resource set. Alternatively, the resource set may include an NR unavailable resource set. Alternatively, the resource set may include an available resource set. Alternatively, the resource set may include an NR candidate resource set and an NR unavailable resource set. Alternatively, the resource set may include an NR candidate resource set and an available resource set. Alternatively, the resource set may include an NR unavailable resource set and an available resource set. Alternatively, the resource set may include an NR candidate resource set, an NR unavailable resource set, and an available resource set.

The available resource set may be understood as a candidate resource set acquired by the user equipment through an LTE perception process. The NR unavailable resource set may be understood as a set of resources that are reserved for SL of LTE or cannot be used by the user equipment for a capability reason. The NR candidate resource set may include a screened candidate resource set. The management entity may select a resource from the candidate resource set. Alternatively, when selecting a resource from the candidate resource set, the management entity excludes resources in the NR unavailable resource set. Alternatively, a resource selected by the management entity from the candidate resource set needs to be included in the available resource set.

In an embodiment, the NR candidate resource set includes one or more of the following: a first candidate resource set acquired through an NR perception process; or a second candidate resource set.

In this embodiment, the NR candidate resource set may include one or more of a first candidate resource set or a second candidate resource set. The first candidate resource set may be a resource set acquired by the UE through an NR perception process. The second candidate resource set may be a set that intersects with the available resource set, a set excluding resources unavailable to NR SL from the available resource set, or a set excluding resources that overlap with the unavailable resource set.

The NR candidate resource set is not specifically limited herein. For example, the NR candidate resource set may include a first candidate resource set. Alternatively, the NR candidate resource set may include a second candidate resource set. Alternatively, the NR candidate resource set may include a first candidate resource set and a second candidate resource set.

In an embodiment, the second candidate resource set includes one or more of the following: a set acquired by excluding, in the NR perception process, resources overlapping with the NR unavailable resource set; the intersection of the candidate resource set acquired in the NR perception process and the available resource set; a set acquired by excluding, through the NR perception process, unavailable resources from a first initial set, where the available resource set is used as the first initial set; or a set acquired by excluding, through the NR perception process, unavailable resources from a second initial set, where the intersection of a set of all candidate resources determined according to a resource selection window and the available resource set is used as the second initial set.

The unavailable resources include one or more of the following: all possible reserved resources on an unmonitored slot; resources overlapping with resources reserved by sidelink control information corresponding to SL transmission whose RSRP measured in a monitored time slot is greater than a first RSRP threshold; or resources overlapping with the NR unavailable resource set.

In this embodiment, the set acquired by excluding, in the NR perception process, resources overlapping with the NR unavailable resource set may be understood as a resource set acquired by excluding resources overlapping with the NR unavailable resource set from the resource set acquired by the UE in the NR perception process.

The intersection of a candidate resource set acquired in the NR perception process and an available resource set may be understood as a resource set consisting of resources that belong to both the candidate resource set acquired by the UE in the NR perception process and the available resource set.

The first initial set may be understood as a set that uses the available resource set as the initial state set. The set acquired by excluding, through the NR perception process, unavailable resources from a first initial set, where the available resource set is used as the first initial set may be understood as a set acquired by excluding unavailable resources from an initial candidate resource set through the NR perception process after the UE uses the available resource set as the initial candidate resource set.

The second initial set may be understood as a set that takes the intersection of a set of all candidate resources determined according to a resource selection window and the available resource set as the initial state set. The intersection of the set of all candidate resources determined according to a resource selection window and the available resource set may be understood as a set consisting of resources that belong to both the set of all candidate resources determined according to the resource selection window and the available resource set.

The intersection of a set of all candidate resources determined according to a resource selection window and the available resource set is used as the second initial set, and the set acquired by excluding, through the NR perception process, unavailable resources from the second initial set may be understood as a set acquired by the UE by excluding unavailable resources from the second initial set through the NR perception process, where the UE takes the intersection of the set of all candidate resources determined according to the resource selection window and the available resource set as the second initial set.

The unavailable resources may include one or more of all possible reserved resources on an unmonitored slot, resources overlapping with resources reserved by sidelink control information corresponding to SL transmission whose RSRP measured in a monitored time slot is greater than a first RSRP threshold, and resources overlapping with the NR unavailable resource set. The first RSRP threshold may be understood as a preset RSRP threshold for measuring the RSRP measured in a monitored time slot, and the value of the first RSRP threshold is not limited herein.

The second candidate resource set is not specifically limited in this embodiment.

In an embodiment, the NR unavailable resource set includes one or more of the following: a reserved resource for LTE SL transmission of other user equipments; a reserved resource for an LTE module of the user equipment; all resources on a slot on which a reserved resource for an LTE process of the user equipment is located; a resource unavailable to the user equipment due to exceeding the transmission capacity; or a resource unavailable to the user equipment due to the limitation of half-duplex.

In an embodiment, the to-be-transmitted information includes a first candidate resource set and an NR unavailable resource set, where the first candidate resource set is acquired by a first module of the user equipment, and the NR unavailable resource set is acquired by a second module of the user equipment.

In this embodiment, the UE may include a first module and a second module. The first module may refer to an NR SL module of the UE. The second module may refer to an LTE SL module of the UE.

The to-be-transmitted information may include a first candidate resource set and an NR unavailable resource set. The first candidate resource set may be acquired by the first module of the UE. For example, the first candidate resource set may be the candidate resource set acquired by the first module of the UE through the NR perception process. The NR unavailable resource set may be acquired by the second module of the UE. For example, the NR unavailable resource set may be a reserved resource set for LTE SL and acquired by the second module of the UE. For example, the NR unavailable resource set may be a reserved resource set for LTE SL and acquired by the second module of the UE according to monitored LTE SL SCI and/or reserved resources of the UE.

In an embodiment, the to-be-transmitted information includes a set acquired by excluding, in an NR perception process, resources overlapping with an NR unavailable resource set, where the set acquired by excluding, in the NR perception process, resources overlapping with the NR unavailable resource set is acquired by a first module of the user equipment, and the NR unavailable resource set is acquired by a second module of the user equipment.

In this embodiment, the to-be-transmitted information may include a set acquired by excluding, in the NR perception process, resources overlapping with the NR unavailable resource set. The set acquired by excluding, in the NR perception process, resources overlapping with the NR unavailable resource set is the second candidate resource set. The set acquired by excluding, in the NR perception process, resources overlapping with the NR unavailable resource set may be acquired through the first module (that is, the NR SL module) of the UE. The NR unavailable resource set may be acquired through the second module ((that is, the LTE SL module) of the UE.

In an embodiment, the to-be-transmitted information includes an NR unavailable resource set acquired by the user equipment or a second module of the user equipment.

In this embodiment, the to-be-transmitted information may include an NR unavailable resource set. The NR unavailable resource set may be acquired by the UE or the second module of the UE, which is not limited herein.

In an embodiment, the to-be-transmitted information includes a first candidate resource set and an NR unavailable resource set, where the first candidate resource set is acquired by the user equipment, and the NR unavailable resource set is acquired by the user equipment.

In the embodiment, the to-be-transmitted information may include a first candidate resource set and an NR unavailable resource set. The first candidate resource set may be a candidate resource set acquired by the UE, for example, a candidate resource set acquired by the UE through the NR perception process. The NR unavailable resource set may be a candidate resource set acquired by the UE, for example, a reserved resource set for LTE SL and acquired by the UE according to monitored LTE SL SCI and/or reserved resources of the UE.

In an embodiment, the to-be-transmitted information includes a set acquired by excluding, in an NR perception process, resources overlapping with an NR unavailable resource set, where the set acquired by excluding, in the NR perception process, the resources overlapping with the NR unavailable resource set and the NR unavailable resource set are acquired by the user equipment.

In this embodiment, the to-be-transmitted information may include a set acquired by excluding, in the NR perception process, resources overlapping with the NR unavailable resource set. The set acquired by excluding, in the NR perception process, the resources overlapping with the NR unavailable resource set and the NR unavailable resource set are acquired by the UE. No limitation is imposed on how to perform acquisition through the UE, and reference may be made to the preceding embodiments.

In an embodiment, the to-be-transmitted information includes a first candidate resource set and an available resource set, where the first candidate resource set is acquired by a first module of the user equipment, and the available resource set is acquired by a second module of the user equipment.

In the embodiment, the to-be-transmitted information may include a first candidate resource set and an available resource set. The first candidate resource set may be acquired by the first module of the UE. The available resource set may be acquired by the second module of the UE. For example, the available resource set may be the candidate resource set acquired by the second module through the LTE perception process.

In an embodiment, the to-be-transmitted information includes the intersection of a candidate resource set acquired in an NR perception process and an available resource set, where the intersection of the candidate resource set acquired in the NR perception process and the available resource set is acquired by a first module of the user equipment, and the available resource set is acquired by a second module of the user equipment.

In this embodiment, the to-be-transmitted information may include the intersection of a candidate resource set acquired in the NR perception process and an available resource set. The intersection of the candidate resource set acquired in the NR perception process and the available resource set may be acquired by a first module of the UE, and the available resource set may be acquired by a second module of the UE.

In an embodiment, the to-be-transmitted information includes an available resource set acquired by the user equipment or a second module of the user equipment.

In this embodiment, the to-be-transmitted information may include an available resource set. The available resource set may be acquired by the UE or the second module of the UE.

In an embodiment, the to-be-transmitted information includes a first candidate resource set and an available resource set, where the first candidate resource set is acquired by the user equipment, and the available resource set is acquired by the user equipment.

In the embodiment, the to-be-transmitted information may include a first candidate resource set and an available resource set. The first candidate resource set may be acquired by the UE. For example, the first candidate resource set may be a candidate resource set acquired by the UE through the NR perception process. The available resource set may be acquired by the UE. For example, the available resource set may be the candidate resource set acquired by the UE through the LTE perception process.

In an embodiment, the to-be-transmitted information includes a set acquired by excluding, through the NR perception process, unavailable resources from a first initial set, where the available resource set is used as the first initial set.

The available resource set is used as the first initial set, and the set acquired by excluding, through the NR perception process, the unavailable resources from the first initial set is acquired by a first module of the user equipment, and the available resource set is acquired by a second module of the user equipment.

In the embodiment, the to-be-transmitted information may include a set acquired by excluding, through the NR perception process, unavailable resources from a first initial set, where the available resource set is used as the first initial set. The available resource set is used as the first initial set, and the set acquired by excluding, through the NR perception process, the unavailable resources from the first initial set may be acquired by the first module of the UE. The available resource set may be acquired by the second module of the UE. For example, the available resource set may be the candidate resource set acquired by the second module of the UE through the LTE perception process.

In an embodiment, the to-be-transmitted information includes a set acquired by excluding, through the NR perception process, unavailable resources from a second initial set, where the intersection of a set of all candidate resources determined according to a resource selection window and the available resource set is used as the second initial set.

The intersection of the set of all candidate resources determined according to the resource selection window and the available resource set is used as the second initial set, and the set acquired by excluding, through the NR perception process, the unavailable resources from the second initial set is acquired by a first module of the user equipment, and the available resource set is acquired by a second module of the user equipment.

In the embodiment, the to-be-transmitted information may include a set acquired by excluding, through the NR perception process, unavailable resources from a second initial set, where the intersection of a set of all candidate resources determined according to a resource selection window and the available resource set is used as the second initial set. The intersection of the set of all candidate resources determined according to the resource selection window and the available resource set is used as the second initial set, and the set acquired by excluding, through the NR perception process, the unavailable resources from the second initial set may be acquired by a first module of the UE. The available resource set may be acquired by the second module of the UE. For example, the available resource set may be the candidate resource set acquired by the second module of the UE through the LTE perception process.

It should be noted that in the preceding embodiments, the NR unavailable resource set may include other resources in addition to the reserved resource set for LTE SL. The other resources may be resources other than the reserved resources for LTE SL transmission of other user equipments and other than the reserved resources for the LTE module of the user equipment. For example, the other resources may be all resources on the time slot where the reserved resources for the LTE process of the user equipment are located, resources that the user equipment cannot use due to exceeding the transmission capacity, and/or resources that the user equipment cannot use due to the limitation of half-duplex. Other resources may be acquired by the second module of the UE, the first module of the UE, or the UE. The acquisition entity of other resources is not limited in this embodiment.

In an embodiment, in the case where the allocated or reserved resource of the user equipment meets one or more of following conditions, conflict exists on the allocated or reserved resource:

The allocated or reserved resource overlaps with a reserved resource indicated by sidelink control information received by the user equipment.

The allocated or reserved resource overlaps with a reserved resource indicated by sidelink control information received by the user equipment, and the transmission priority of the user equipment on the allocated or reserved resource is lower than the transmission priority indicated by sidelink indication information.

The allocated or reserved resource overlaps with a reserved resource indicated by sidelink control information received by the user equipment, and RSRP corresponding to a physical sidelink control channel (PSCCH) that corresponds to the sidelink control information or RSRP corresponding to a physical sidelink shared channel (PSSCH) that corresponds to the sidelink control information is greater than a second RSRP threshold.

The allocated or reserved resource overlaps with a reserved resource indicated by sidelink control information received by the user equipment, and the user equipment is a target receiving terminal of a transmission block sent on the reserved resource indicated by the sidelink control information.

A target receiving terminal of a transmission block sent on the allocated or reserved resource processes a sleep state of discontinuous reception (DRX).

The user equipment cannot use the allocated or reserved resource due to the limitation of the transmission capability.

The allocated or reserved resource cannot be used due to the limitation of half-duplex.

In this embodiment, RSRP corresponding to the PSCCH or the PSSCH may be understood as RSRP acquired by measuring the reference signal (for example, a demodulation reference signal, a channel state information reference signal, or a phase tracking reference signal) corresponding to the PSCCH or PSSCH. The second RSRP threshold may be a preset threshold for measuring the RSRP corresponding to the PSCCH that corresponds to the SCI or the RSRP corresponding to the PSSCH that corresponds to the SCI. The value of the second RSRP threshold is not specifically limited herein.

It should be noted that the lower value of a transmission priority indicates a higher corresponding transmission priority. The first RSRP threshold and the second RSRP threshold may be the same parameter or different parameters. When the first RSRP threshold and the second RSRP threshold are different parameters, if one RSRP threshold is not configured and the other RSRP threshold is configured, the value of the un-configured RSRP threshold is the same as the value of the configured RSRP threshold.

In an embodiment, the method also includes transmitting one or more of the following: a resource pool corresponding to a resource set; a bandwidth part corresponding to a resource set; a start position of a time window of a resource set; a reference time slot of resources in a resource set; a time-frequency position of resources in a resource set; or a resource set type.

In this embodiment, the to-be-transmitted information may also include one or more of a resource pool corresponding to a resource set, a bandwidth part corresponding to a resource set, a start position of a time window of a resource set, a reference slot of resources in a resource set, a time-frequency position of resources in a resource set, and a resource set type.

The resource set type may be used to indicate which resource set or resource sets are to be transmitted. For example, the resource set type may be used to indicate whether the to-be-transmitted resource set is an NR candidate resource set, an NR unavailable resource set, an available resource set, an NR candidate resource set, or an NR unavailable resource set.

The transmission method on the UE side is exemplarily described below by different embodiments.

### Embodiment one: UE side

The user equipment (that is, the UE) determines at least one of the following information: resource set or conflict information. Then the UE reports the determined information (that is, the to-be-transmitted information) to a management entity so that the management entity selects a resource for the UE according to the information determined by the UE (that is, the to-be-transmitted information indicates that a management entity selects a resource for the user equipment). The management entity may be considered as a higher layer, and the management entity may include one of the following: a higher layer of the UE, a higher layer of a first module of the UE, a higher layer of a second module of the UE, an NR base station, or an NR network.

The resource set includes at least one of the following: an NR candidate resource set, an NR unavailable resource set, or an available resource set. The NR candidate resource set may include one of the following: a first candidate resource set or a second candidate resource set. The first candidate resource set is a resource set acquired by the UE through an NR perception process. The second candidate resource set may include one of the following: a resource set acquired by the UE by excluding, in the NR perception process, resources overlapping with the NR unavailable resource set (that is, a set acquired by excluding, in the NR perception process, resources overlapping with an NR unavailable resource set); a resource set acquired by the UE taking the intersection of a candidate resource set acquired in the NR perception process and an available resource set (that is, the intersection of the candidate resource set acquired in the NR perception process and the available resource set); a resource set acquired by the UE by excluding, through the NR perception process, unavailable resources from an initial candidate resource set, where the UE uses the available resource set as an initial candidate resource set (that is, the first initial set) (that is, a set acquired by excluding, through the NR perception process, unavailable resources from a first initial set, where the available resource set is used as the first initial set); or a resource set acquired by the UE by excluding, through the NR perception process, unavailable resources from a second initial set, where the UE uses the intersection of a set of all candidate resources determined according to a resource selection window and the available resource set as an initial candidate resource set (that is, the second initial set) (that is, a set acquired by excluding, through the NR perception process, unavailable resources from a second initial set, where the intersection of a set of all candidate resources determined according to a resource selection window and the available resource set is used as the second initial set). The NR unavailable resource set is a set of resources that are reserved for LTE SL or cannot be used by the UE for a capability reason. The available resource set is the candidate resource set acquired by the UE through the LTE perception process. The conflict information may indicate a conflict resource in the resources allocated to the UE.

In an embodiment, the NR unavailable resource set may include at least one of the following: a reserved resource for LTE SL transmission of other UEs, a reserved resource for the LTE module of the UE, all resources on the time slot where reserved resources for another process (for example, LTE SL) of the UE are located, a reserved resource for another process (for example, LTE SL) of the UE, a resource that the UE cannot use due to exceeding the transmission capacity, or a resource that the UE cannot use due to the limitation of half-duplex.

In an embodiment, information determined by the UE (that is, to-be-transmitted information) may include a first candidate resource set and an NR unavailable resource set, and the UE reports the determined information to a higher layer. The UE may include a first module and a second module. The first candidate resource set is the candidate resource set acquired by the first module through the NR perception process. The NR unavailable resource set includes the reserved resource set for LTE SL and acquired by the second module.

For example, the UE includes an NR SL module (that is, a first module) and an LTE SL module (that is, a second module). The NR SL module acquires a candidate resource set SA (that is, a first candidate resource set) through the NR perception process and provides SA to a higher layer. The LTE SL module acquires an LTE SL reserved resource set Sc (that is, the NR unavailable resource set) according to the monitored LTE SL SCI and/or the reserved resources of the LTE SL module. The LTE SL module provides Sc to the NR SL module, and the NR SL module provides the Sc to the higher layer. Alternatively, the LTE SL module directly provides Sc to the higher layer so that the higher layer selects a resource for the NR SL module according to SA and Sc to avoid resource conflict with LTE SL.

In an embodiment, information determined by the UE may include a second candidate resource set, and the UE reports the determined information to a higher layer. The UE includes a first module and a second module. The second candidate resource set is a candidate resource set acquired by the first module by excluding, through the NR perception process, resources overlapping with the NR unavailable resource set. The NR unavailable resource set includes the LTE SL reserved resource set acquired by the second module.

For example, the UE includes an NR SL module (that is, a first module) and an LTE SL module (that is, a second module). The LTE SL module acquires an LTE SL reserved resource set Sc according to the monitored LTE SL SCI and/or the reserved resources of the LTE SL module and provides Sc to the NR SL module. The NR SL module acquires a candidate resource set SB (that is, the second candidate resource set) by excluding, through the NR perception process, resources (that is, the unavailable resources may include resources overlapping with the NR unavailable resource set) overlapping with Sc and provides SB to the higher layer. In this manner, the higher layer can select a resource for the NR SL module according to SB to avoid resource conflict with LTE SL.

In an embodiment, the information determined by the UE includes an NR unavailable resource set. The UE reports the determined information to a higher layer. The NR unavailable resource set may include an LTE SL reserved resource set acquired by the UE or the second module of the UE according to the monitored LTE SL SCI and/or the reserved resources of the UE or the second module of the UE.

For example, the UE or the LTE SL module (the second module) of the UE acquires an LTE SL reserved resource set Sc according to the monitored LTE SL SCI and/or the reserved resources of the UE or the LTE SL module of the UE and provides Sc to a higher layer. When the UE includes the LTE SL module and the NR SL module, the LTE SL module provides Sc to the NR SL module, and then the NR SL module provides Sc to the higher layer, or the LTE SL module directly provides the Sc to the higher layer. Thus, the higher layer can select a resource that does not overlap with Sc when selecting a resource for the UE.

In an embodiment, information determined by the UE may include a first candidate resource set and an NR unavailable resource set, and the UE reports the determined information to a higher layer. The first candidate resource set is a candidate resource set acquired by the UE through the NR perception process. The NR unavailable resource set includes an LTE SL reserved resource set acquired by the UE according to monitored LTE SL SCI and/or reserved resources of the UE.

For example, the UE acquires a candidate resource set SA through the NR perception process and acquires an LTE SL reserved resource set Sc according to the monitored LTE SL SCI and/or the reserved resources of the UE. The UE provides SA and Sc to a higher layer (the process in which Sc is provided to the higher layer is similar to that in the preceding embodiments and that in the following embodiments, and details are not described herein) so that the higher layer selects a resource for the NR SL UE according to SA and Sc to avoid resource conflict with LTE SL. It should be noted that if the number of remaining resources is less than the threshold X·Mₜₒₜₐₗ after the resources overlapping with Sc are excluded from SA, the higher layer decides whether to use the resources in Sc. X refers to the percentage of the number of resources in the candidate resource set configured to be reported to the higher layer to the total number of candidate resources in the resource selection window or a ratio converted from the percentage. Mₜₒₜₐₗ refers to the total number of candidate resources in the resource selection window.

In an embodiment, for a scenario where LTE SL and NR SL coexist, X refers to the percentage of the number of resources in the candidate resource set configured to be reported by the UE to the higher layer to the total number of initial candidate resources in the resource selection window or a ratio converted from the percentage.

In an embodiment, for a scenario where LTE SL and NR SL coexist, X refers to the percentage of the number of resources in the candidate resource set configured to be reported by the UE to the higher layer to the total number of initial candidate resources in the resource selection window or a ratio converted from the percentage. If the UE is not provided with X for a scenario where LTE SL and NR SL coexist, X corresponding to a scenario where LTE SL and NR SL do not coexist may be applied to the scenario where LTE SL and NR SL coexist.

In an embodiment, information determined by the UE includes a second candidate resource set, and the UE reports the determined information to a higher layer. The second candidate resource set is a candidate resource set acquired by the UE by excluding, through the NR perception process, resources overlapping with the NR unavailable resource set. The NR unavailable resource set includes the LTE SL reserved resource set acquired by the UE.

For example, the UE acquires an LTE SL reserved resource set Sc according to the monitored LTE SL SCI and/or the reserved resources of the UE. The UE excludes resources overlapping with Sc through the NR perception process, thereby acquiring an NR candidate resource set SB. The higher layer selects a resource based on SB to avoid resource conflict with LTE SL.

In an embodiment, an LTE SL reserved resource includes at least one of the following: a reserved resource for another LTE SL UE, or a reserved resource for the second module.

In an embodiment, information determined by the UE includes a first candidate resource set, and the UE reports the determined information to a higher layer. The first candidate resource set is a candidate resource set acquired by the UE through the NR perception process.

For example, SL resources of the NR UE are scheduled by a base station (a higher layer) (that is, the resource allocation mode adopted by the UE is mode 1). The UE acquires a candidate resource set SA through the NR perception process and provides SA to the base station so that the base station selects a resource for the UE based on SA to avoid resource conflict with the UE of NR mode 2.

In an embodiment, information determined by the UE includes a first candidate resource set and an available resource set, and the UE reports the determined information to a higher layer. The UE includes a first module and a second module. The first candidate resource set is the candidate resource set acquired by the first module through the NR perception process. The available resource set is the candidate resource set acquired by the second module through the LTE perception process.

For example, the UE includes an NR SL module and an LTE SL module. The NR SL module acquires a candidate resource set SA through the NR perception process and provides SA to a higher layer. The LTE SL module acquires a candidate resource set Sp (that is, an available resource set) through the LTE perception process and provides Sp to the NR SL module. The NR SL module provides Sp to the higher layer, or the LTE SL module directly provides Sp to the higher layer (the process in which Sp is provided to the higher layer in the following embodiments is similar to that in this embodiment and will not be repeated) so that the higher layer selects a resource for the NR SL module according to SA and Sp to avoid resource conflict with LTE SL.

In an embodiment, information determined by the UE includes a second candidate resource set, and the UE reports the determined information to a higher layer. The UE includes a first module and a second module. The second candidate resource set is the intersection of the candidate resource set acquired by the first module through the NR perception process and the available resource set. The available resource set is the candidate resource set acquired by the second module through the LTE perception process.

For example, the NR SL module acquires a candidate resource set SA through the NR perception process. The LTE SL module acquires a candidate resource set SD (that is, the available resource set) through the LTE perception process. The second module provides Sp to the first module, and the first module acquires the second candidate resource set SB by taking the intersection of SA and Sp and reports the second candidate resource set SB to the higher layer.

In this embodiment, the second candidate resource set may also be a candidate resource set acquired by the first module through the NR perception process using the available resource set Sp as the initial candidate resource set; or the second candidate resource set may also be a candidate resource set acquired by the first module through the NR perception process using the intersection of a resource set of all candidates determined according to a resource selection window and an available resource set as the initial candidate resource set.

In an embodiment, the information determined by the UE may include an available resource set. The UE reports the determined information to a higher layer.

For example, the UE or the LTE SL module (the second module) of the UE acquires a candidate resource set Sp through the LTE perception process and provides Sp to a higher layer. Thus, the higher layer can select a resource from Sp when selecting a resource for the UE. If the UE has a function of NR perception and provides a candidate resource set SA acquired through the NR perception process to the higher layer, whether the higher layer selects a resource from SD or SA is implementation dependent.

In an embodiment, information determined by the UE may include a first candidate resource set and an available resource set, and the UE reports the determined information to a higher layer. The first candidate resource set is a set of candidate resources acquired by the UE through the NR perception process. The available resource set is a candidate resource set acquired by the UE through the LTE perception process.

For example, the UE acquires a candidate resource set SA through the NR perception process and acquires a candidate resource set Sp through the LTE perception process. The UE provides SA and Sp to a higher layer so that the higher layer selects a resource for the NR SL UE based on SA and Sp. For example, the higher layer selects a resource from the intersection of SA and SD to avoid resource conflict with LTE SL. It should be noted that if the number of resources in the intersection of SA and Sp is less than the threshold X·Mₜₒₜₐₗ, whether to select a resource from SA or from the intersection depends on the implementation.

In an embodiment, information determined by the UE may include a second candidate resource set, and the UE reports the determined information to a higher layer. The second candidate resource set is the intersection of a candidate resource set acquired by the UE through the NR perception process and an available resource set. The available resource set is the candidate resource set acquired by the UE through the LTE perception process.

For example, the UE acquires a candidate resource set SA through the NR perception process and acquires a candidate resource set Sp through the LTE perception process. The UE takes the intersection of SA and Sp to acquire a second candidate resource set SB and reports the second candidate resource set to a higher layer. In this embodiment, the second candidate resource set may also be a candidate resource set acquired by the UE through the NR perception process using the available resource set as an initial candidate resource set; or the second candidate resource set may also be a candidate resource set acquired by the UE through the NR perception process using the intersection of an initial candidate resource set determined according to a resource selection window and an available resource set as the initial candidate resource set.

In an embodiment, information determined by the UE may include a second candidate resource set, and the UE reports the determined information to a higher layer. The UE includes a first module and a second module. The second candidate resource set is a candidate resource set acquired by the first module by excluding, through the NR perception process, resources overlapping with the NR unavailable resource set. The NR unavailable resource set is acquired by the second module and then provided to a higher layer of the first module, and the higher layer of the first module then provides the NR unavailable resource set to a physical layer of the first module.

For example, the second module (LTE SL module) of the UE acquires an LTE SL reserved resource set Sc (that is, the unavailable resource set) according to the monitored LTE SL SCI and/or the reserved resources of the second module. The second module provides Sc to the higher layer of the first module (LTE SL module). The higher layer of the first module provides Sc to the physical layer of the first module. The physical layer of the first module excludes the resources overlapping with the unavailable resource set through the perception process to acquire a second candidate resource set SB and then reports SB to the higher layer.

In an embodiment, information determined by the UE may include a second candidate resource set, and the UE reports the determined information to a higher layer. The UE includes a first module and a second module. The second candidate resource set is the intersection of the candidate resource set acquired by the first module through the NR perception process and the available resource set. The available resource set is acquired by the second module and then provided to a higher layer of the first module, and the higher layer of the first module then provides the available resource set to a physical layer of the first module.

For example, the second module (LTE SL module) acquires a candidate resource set (that is, the available resource set) Sp through the LTE perception process and provides Sp to the higher layer of the first module (NR SL module). The higher layer of the first module provides SD to the physical layer of the first module, and the physical layer of the first module takes the intersection of the candidate resource set acquired through the NR perception process and SD to obtain a second candidate resource set and reports the second candidate resource set to the higher layer. In this embodiment, the second candidate resource set may also be a candidate resource set acquired by the physical layer of the first module through the NR perception process using the available resource set Sp as the initial candidate resource set; or the second candidate resource set may also be a candidate resource set acquired by the first module through the NR perception process using the intersection of an initial candidate resource set determined according to a resource selection window and an available resource set as the initial candidate resource set.

In an embodiment, information determined by the UE may include a second candidate resource set, and the UE reports the determined information to a higher layer. The UE includes a first module and a second module. The second candidate resource set is a candidate resource set acquired by the first module through the NR perception process using an available resource set as an initial candidate resource set. The available resource set is provided to a higher layer of the first module by the second module after being acquired by the second module and then provided to the physical layer of the first module by the higher layer of the first module.

In an embodiment, the process where the available resource set is used as the initial candidate resource set through the NR perception process to acquire the second candidate resource set includes the following: The UE uses the available resource set as the initial candidate resource set SA, excludes from SA all possible reserved resources by an unmonitored time slot, and excludes resources overlapping with resources reserved by SCI corresponding to SL transmission whose RSRP measured in a monitored time slot is greater than the RSRP threshold (that is, the first RSRP threshold) (in other words, the unavailable resources may include one or more of the following: all possible reserved resources on an unmonitored slot; or resources overlapping with resources reserved by sidelink control information corresponding to SL transmission whose RSRP measured in a monitored time slot is greater than a first RSRP threshold), thereby obtaining the second candidate resource set SB. In addition, the unavailable resources may also include resources overlapping with the NR unavailable resource set.

In an embodiment, information determined by the UE may include a second candidate resource set, and the UE reports the determined information to a higher layer. The UE includes a first module and a second module. The second candidate resource set is a candidate resource set acquired by the first module through the NR perception process using the intersection of an initial candidate resource set determined according to a resource selection window and an available resource set as the initial candidate resource set. The available resource set is acquired by the second module and then provided to a higher layer of the first module by the second module. The higher layer of the first module then provides the available resource set to the physical layer of the first module.

In an embodiment, the UE determines all candidate resources within a resource selection window [n+T₁, n+T₂] as an initial candidate resource set S_{A1}, and the process where the intersection of S_{A1} and an available resource set is used as the initial candidate resource set to acquire a second candidate resource set includes the following: The intersection of S_{A1} and an available resource set is taken as the initial candidate resource set SA. All possible reserved resources by an unmonitored time slot are excluded from SA, and the resources overlapping with the resources reserved by SCI corresponding to the SL transmission whose RSRP measured in a monitored time slot is greater than the RSRP threshold are excluded, so as to obtain the second candidate resource set SB. Then SB is reported to the higher layer. It should be noted that if the number of resources in the initial candidate resource set SA is less than the threshold X·Mₜₒₜₐₗ, whether the UE considers the available resource set when determining the initial candidate resource set depends on the UE implementation.

In an embodiment, the UE determines all candidate resources in a resource selection window [n+T₁, n+T₂] as an initial candidate resource set S_{A1}, and the process where the intersection of S_{A1} and an available resource set is used as the initial candidate resource set to acquire a second candidate resource set includes the following: The intersection of S_{A1} and an available resource set is used as the initial candidate resource set SA. All possible reserved resources in an unmonitored time slot are excluded from SA. Resources overlapping with the resources reserved by SCI corresponding to the SL transmission whose RSRP measured in a monitored time slot is greater than the RSRP threshold are excluded. Resources overlapping with NR unavailable resources are excluded. Thus, the second candidate resource set SB is obtained and then is reported to the higher layer.

In an embodiment, the process where the first module excludes resources overlapping with the NR unavailable resource set through the NR perception process to obtain a second candidate resource set includes the following: The first module acquires an initial candidate resource set SA according to the configuration of a higher-layer. Then the first module excludes from SA all possible reserved resources by an unmonitored time slot, excludes resources overlapping with the resources reserved by SCI corresponding to the SL transmission whose RSRP measured in a monitored time slot is greater than the RSRP threshold, and excludes resources overlapping with the NR unavailable resource set to obtain the second candidate resource set SB (that is, a set obtained after unavailable resources are excluded from SA).

In an embodiment, the higher layer includes one of the following: a higher layer of the UE, a higher layer of a first module, a higher layer of a second module, an NR base station, or an NR network.

It should be noted that in all the preceding embodiments, if the NR unavailable resource set includes other resources in addition to the LTE SL reserved resource set, it is also necessary to exclude resources that overlap with other resources when a resource set is determined or a higher layer selects a resource.

In an embodiment, in the case where resource r1 allocated or reserved to the UE meets at least one of the following conditions, the UE considers that conflict exists on the allocated or reserved resource r1:

The allocated or reserved resource r1 overlaps with a reserved resource r2 indicated by SCI received by the UE.

The allocated or resource r1 overlaps with a reserved resource r2 indicated by SCI received by the UE, and the transmission priority of the UE on the allocated or reserved resource r1 is lower than the transmission priority indicated by SCI.

The allocated or reserved resource r1 overlaps with a reserved resource r2 indicated by SCI received by the UE, and RSRP corresponding to a PSCCH that corresponds to the SCI or RSRP corresponding to a PSSCH that corresponds to the SCI is greater than the RSRP threshold (that is, a second RSRP threshold).

The allocated or reserved resource r1 overlaps with a reserved resource r2 indicated by SCI received by the UE, and the UE is the target receiving UE of a transmission block sent on the reserved resource r2.

The target receiving UE of a transmission block sent on the allocated or reserved resource r1 processes a sleep state of DRX.

The UE cannot use the allocated or reserved resource r1 due to the limitation of the transmission capability.

The allocated or reserved resource r1 cannot be used due to the limitation of half-duplex.

For example, the UE monitors a physical downlink control channel and acquires an SL resource (that is, resource r1) allocated to the UE by the NR base station through the downlink control information (DCI). Before the SL resource, the UE acquires a resource reserved for another UE (that is, reserved resource r2) by monitoring the NR or LTE SL SCI. r2 overlaps with the SL resource, and the SL transmission priority indicated by the SCI is higher than the priority of the SL transmission sent by the UE on the SL resource (that is, the lower the priority value, the higher the priority), and then the UE considers that conflict exists on the SL resource.

In an embodiment, the RSRP threshold is provided by a higher layer, and the higher layer provides the RSRP threshold for each priority pair (pᵢ, pⱼ). pᵢ is the priority value indicated by the received SCI. p; is the priority corresponding to the SL transmission of the UE performing resource selection.

In an embodiment, for a scenario where LTE SL and NR SL coexist, the UE is provided with an RSRP threshold. For example, in addition to being provided with an RSRP threshold corresponding to a scenario where LTE SL and NR SL do not coexist, the UE also needs to be provided with an RSRP threshold corresponding to a scenario where LTE SL and NR SL coexist.

In an embodiment, for a scenario where LTE SL and NR SL coexist, the UE is provided with an RSRP threshold. If the UE is not provided with an RSRP threshold corresponding to a scenario where LTE SL and NR SL coexist, the UE may use the RSRP threshold corresponding a scenario where LTE SL and NR SL do not coexist.

In an embodiment, the UE receives a perception measurement configuration and performs perception measurement according to the perception measurement configuration. The perception measurement configuration includes at least one of the following: NR perception measurement configuration, or LTE perception measurement configuration.

In an embodiment, the NR perception measurement configuration includes at least one of the following: a resource pool (the resource reported to the higher layer is the resource in the resource pool); a transmission priority in the SCI associated with NR SL transmission; a remaining packet (or data packet) delay budget; the number of sub-channels used for NR SL transmission in a time slot; an NR SL resource reservation interval; a position of a resource selection window; a percentage of the number of resources in a candidate resource set reported to the higher layer to the total number of initial candidate resources in a resource selection window or ratio converted from the percentage; a resource set type; a resource set requiring re-evaluation check; a resource set requiring preemption check; a NR SL resource re-selection counter; whether to consider the reserved resources for LTE SL transmission in the NR perception process; or configuration of an LTE SL resource pool. The resource set type is used to configure which resource set or sets are reported. For example, a reported resource set is an NR candidate resource set, an NR unavailable resource set, an NR available resource set, an NR candidate resource set and an NR unavailable resource set, or an NR candidate resource set and an NR available resource set. The resource set type is used to determine which candidate resource set is reported.

In an embodiment, the LTE perception measurement configuration includes at least one of the following: a transmission priority in the SCI associated with LTE SL transmission; the number of sub-channels used for LTE SL transmission in a subframe (or time slot); an LTE SL resource reservation interval; an LTE SL resource re-selection counter; a percentage of the number of resources in a candidate resource set reported to the higher layer to the total number of initial candidate resources in a resource selection window or ratio converted from the percentage; or configuration of an LTE SL resource pool.

In an embodiment, parameters in the NR perception measurement configuration and the LTE perception measurement configuration meet at least one of the following: The number of sub-channels used for SL transmission may be converted into the bandwidth of the same SL transmission. The resource reservation period may be converted into the same logical period. The transmission priorities in the SCI associated with the SL transmission is the same. The resource re-selection counter is the same. The percentage of the number of resources in a candidate resource set reported to the higher layer to the total number of initial candidate resources in a resource selection window or the ratio converted from the percentage is the same. The logical period may refer to a period in units of time slots or subframes in a resource pool, that is, only time slots or subframes in the resource pool are counted.

In an embodiment, the information (that is, the to-be-transmitted information) reported by the UE also includes at least one of the following: a resource pool corresponding to a resource set, a BWP corresponding to a resource set, a start position of a time window for acquiring a resource set, a reference time slot of resources in a resource set, a time-frequency position of resources in a resource set, or a resource set type. The resource set type is used to indicate which resource set or resource sets are reported. For example, the resource set type is used to indicate whether the reported resource set is an NR candidate resource set, an NR unavailable resource set, an NR available resource set, an NR candidate resource set and an NR unavailable resource set, an NR candidate resource set and an NR available resource set, or a candidate resource set.

In an embodiment, when the higher layer is a base station, the information reported by the UE also includes a resource to be used by the UE. That is, the UE reports the resource set to the base station and does not need to wait for the base station to allocate an SL resource to the UE. The UE may first select a resource for SL transmission and report the selected resource to the base station. The UE, by itself, selects a resource for SL transmission. Thus, traffic delay can be reduced.

In an embodiment, if a resource rx (also referred to as a re-evaluation resource rx) in a resource set requiring re-evaluation check does not belong to an NR candidate resource set, the UE reports the re-evaluation resource rx to the higher layer.

In an embodiment, if a resource ry (also referred to as a re-preemption resource ry) in a resource set requiring preemption check meets a preemption condition, the UE reports the re-preemption resource ry to a higher layer. For example, the preemption condition may refer to Chapter 8 of the protocol TS38.214, which is not limited herein.

In an embodiment, a resource unavailable to the UE due the limitation of the transmission capability may include the following: a selected resource involving SL transmission in other carriers or resource pools, the resource uncapable of being used by the UE due to the limitation of the number of carriers that the UE can transmit simultaneously, the limitation in the supported carrier combination, or the interruption of the radio frequency re-tuning time.

In an embodiment, a resource unavailable to the UE due to the limitation of half-duplex may include a slot resource on which the UE is to perform reception but cannot perform sending simultaneously due to the limitation of half-duplex. For example, the LTE SL module of the UE needs to receive LTE SL data on a specific slot, and the priority corresponding to the LTE SL data is higher than that of NR SL data to be sent. Due to the limitation of half-duplex, the UE cannot send NR SL data on the slot. That is, a resource corresponding to the slot is the resource unavailable to the UE due to the limitation of half-duplex.

In an embodiment, a resource that cannot be used due to the limitation of half-duplex is the resource where the LTE module of the UE wants to receive LTE SL data. The LTE SL data to be received needs to meet at least one of the following conditions:

The priority corresponding to the LTE SL data to be received is higher than the priority corresponding to the NR SL data to be sent.

The priority corresponding to LTE SL data to be received is higher than a priority threshold, where the priority threshold is provided by a higher layer.

The RSRP measurement value corresponding to the LTE SL data previously or most recently sent by the target sending UE of the LTE SL data to be received is greater than a RSRP threshold. The RSRP threshold is provided by a higher layer and includes one of the following: RSRP threshold for each priority pair (pᵢ, pⱼ), RSRP threshold for the priority pᵢ, or RSRP threshold independent of the priority. pᵢ is the priority value indicated by SCI of the received LTE SL. pⱼ is the priority corresponding to the SL transmission of the UE performing resource selection. Alternatively, p; is the transmission priority of the UE on a selected resource (that is, the priority corresponding to the SL transmission).

In an embodiment, the UE reports resource set information in time slot X, and the time slot X satisfies at least one of the following conditions:

After slot n1, the interval between slot n1 and time slot X is T11.

After slot n1, the interval between slot n1 and time slot X is at least T12.

Before start slot n2 of a resource selection window, the interval between slot n2 and time slot X is T13.

Before start slot n2 of a resource selection window, the interval between slot n2 and time slot X is at least T14.

Before time slot n3 where the earliest resource in a resource set is located, the interval between slot n3 and time slot X is T15.

Before time slot n3 where the earliest resource in a resource set is located, the interval between slot n3 and time slot X is at least T16.

Slot n1 is one of the following: a time slot triggering the UE to determine resource set information, a time slot triggering the UE to determine a sending resource that carries the resource set information, or a time slot for the UE to receive the perception measurement configuration.

In an embodiment, the UE reports conflict information in time slot Y, and the time slot Y satisfies at least one of the following conditions:

After the UE receives time slot m1 of resource scheduling information, the interval between time slot Y and time slot m1 is T21.

After the UE receives time slot m1 of resource scheduling information, the interval between time slot Y and time slot m1 is at least T22.

Before time slot m2 where the earliest resource in conflict resources is located, the interval between time slot Y and time slot m2 is T23.

Before time slot m2 where the earliest resource in conflict resources is located, the interval between time slot Y and time slot m2 is at least T24.

In an embodiment, the unit of Tx may be one of the following: physical slot, logic slot, subframe, orthogonal al frequency-division multiplexing (OFDM) symbol, millisecond, microsecond, Tc, or multiple of Tc. In the embodiment, X=11, 12, 13, 14, 15, 16, 21, 22, 23, or 24. Tc is the minimum time unit in the NR system.

In an embodiment, the UE is configured with a Tx value by one of the following methods:

Radio resource control (RRC) signaling configures at least one Tx value and indicates one of the Tx values by downlink control information.

A list of Tx values is predefined, and one of the Tx values is indicated by downlink control information.

The RRC signaling configures at least one Tx value and indicates one of the Tx values by a media access control (MAC) control unit (CE).

A list of Tx values is predefined, and one of the Tx values is indicated by an MAC CE.

RRC signaling configures a Tx value.

In this embodiment, X=11, 12, 13, 14, 15, 16, 21, 22, 23, or 24.

In an embodiment, the UE includes a first module and a second module, and the second module sends an NR unavailable resource set to the first module. If a resource allocated to the first module overlaps with the NR unavailable resource set, the UE considers that conflict exists on the allocated resource and reports the conflict information to a higher layer.

In an embodiment, the UE includes a first module and a second module, and the second module sends an available resource set to the first module. If a resource allocated to the first module does not belong to the available resource set, the UE considers that conflict exists on the allocated resource and reports the conflict information to a higher layer.

In an embodiment, the UE includes a first module and a second module. If a resource allocated to the first module does not belong to an NR candidate resource set, the UE considers that conflict exists on the allocated resource and reports the conflict information to a higher layer.

In an embodiment, if a resource allocated to the UE overlaps with an NR unavailable resource set, the UE considers that conflict exists on the allocated resource and reports the conflict information to a higher layer.

In an embodiment, if a resource allocated to the UE does not belong to an available resource set, the UE considers that conflict exists on the allocated resource and reports the conflict information to a higher layer.

In an embodiment, if a resource allocated to the UE does not belong to an NR candidate resource set, the UE considers that conflict exists on the allocated resource and reports the conflict information to a higher layer.

Optionally, in the preceding embodiments, the resource allocated to the UE may refer to the resource allocated or reserved by a higher layer for the UE for NR SL transmission.

In an embodiment, the conflict information includes at least one of the following: a time domain position of a conflict resource, whether conflict appears periodically, or period when conflict appears. For example, the base station reserves or allocates three resources to the UE, and the resource reservation period is p. That is, assuming that in time slot tₘ in a resource pool, the base station reserves a group of sub-channels for the UE as the time-frequency resources for SL transmission, and the resource reservation period is p; then the same group of sub-channels in time slot t_{m+j*p} (in this formula, p denotes the logical period, that is, only the time slots of the resource pool are counted) are also SL transmission resources of the UE, where j=1, 2, . . . . Cresel-1. Cresel is the resource re-selection counter. The conflict information is used to indicate the conflict of the three reserved resources that recur with a period of p. For example, the conflict information may be as follows: Conflict exists on the first reserved resource, and the period of the conflict is p1; conflict exists on the second reserved resource, and the conflict does not occur periodically.

In an embodiment, the time domain position of a conflict resource may be indicated by the number of a reserved resource in the first N reservation periods, where N is determined by configuration or pre-configuration. For example, the base station reserves three resources for the UE. The first reserved resource is the first resource in the first resource reservation period. The second reserved resource is the second resource in the first resource reservation period. . . . The fourth reserved resource is the first resource in the second resource reservation period. The rest can be processed in the same manner. The UE reports the resource number of the conflict resource, and the base station can determine which resource is the conflict resource.

In an embodiment, the UE reports information through at least one of the following channels or signaling: PUCCH, physical uplink shared channel (PUSCH), MAC CE, or RRC signaling.

In an embodiment, the UE also receives whether to receive indication information from a higher layer, and whether to receive indication information includes at least one of the following: whether to receive a resource set or whether to receive conflict information. For example, one bit (bit) is used to indicate whether a higher layer can receive a resource set. The bit value of 0 indicates that the resource set cannot be received. The bit value of 1 indicates that the resource set can be received. One bit is used to indicate whether the higher layer can receive conflict information. The bit value of 0 indicates that the conflict information cannot be received. The bit value of 1 indicates that the conflict information can be received.

In an embodiment, the UE is configured to enable or disable the reporting of a resource set or reporting of conflict information for each resource pool. For example, the UE needs to perform reporting only when a higher layer is configured to enable the reporting of a resource set or reporting of conflict information.

In an embodiment, the UE is configured to enable or disable the reporting of one or more resource sets or reporting of conflict information for each resource pool. For example, the UE needs to perform reporting only when a higher layer is configured to enable the reporting of one or more resource sets or reporting of conflict information.

FIG. 2 is a flowchart of another transmission method according to an embodiment. As shown in FIG. 2, the method provided in the embodiment may be applied to a management entity and includes S210 and S220.

In S210, to-be-transmitted information is acquired, where the to-be-transmitted information indicates that a management entity selects a resource for the user equipment.

In S220, the resource is selected based on the to-be-transmitted information.

In the embodiment, the to-be-transmitted information may be used to indicate that a management entity selects a resource for the UE. The to-be-transmitted information acquired by the management entity may include a resource set and/or conflict information. The process of how the management entity acquires the to-be-transmitted information is not specifically limited herein.

The management entity acquires the to-be-transmitted information transmitted by the UE and selects a resource for the UE based on the to-be-transmitted information (that is, it may be understood as that the management entity allocates a corresponding resource to the UE according to the to-be-transmitted information transmitted by the UE).

In this embodiment, the management entity selects a resource based on the acquired to-be-transmitted information to allocate an available resource without causing resource conflict to the UE, thereby achieving coexistence of SL communication within the same frequency resource and avoiding resource conflict that exists when resources coexist.

In an embodiment, the to-be-transmitted information includes conflict information, and the conflict information indicates a conflict resource in an allocated or reserved resource.

In an embodiment, the to-be-transmitted information includes a resource set, and the resource set includes one or more of the following: an NR candidate resource set; an NR unavailable resource set, where the NR unavailable resource set is a set of resources that are reserved for SL of LTE or cannot be used by the user equipment for a capability reason; or an available resource set, where the available resource set is a candidate resource set acquired by the user equipment through an LTE perception process.

In an embodiment, the NR candidate resource set includes one or more of the following: a first candidate resource set acquired by the UE through an NR perception process; or a second candidate resource set.

In an embodiment, the second candidate resource set includes one or more of the following: a set acquired by excluding, in the NR perception process, resources overlapping with the NR unavailable resource set; the intersection of the candidate resource set acquired through the NR perception process and the available resource set; a set acquired by excluding, through the NR perception process, unavailable resources from a first initial set, where the available resource set is used as the first initial set; or a set acquired by excluding, through the NR perception process, unavailable resources from a second initial set, where the intersection of a set of all candidate resources determined according to a resource selection window and the available resource set is used as the second initial set.

The unavailable resources include one or more of the following: all possible reserved resources on an unmonitored slot; resources overlapping with resources reserved by sidelink control information corresponding to SL transmission whose RSRP measured in a monitored time slot is greater than a first RSRP threshold; or resources overlapping with the NR unavailable resource set.

In an embodiment, the method also includes receiving one or more of the following: a resource pool corresponding to a resource set; a bandwidth part corresponding to a resource set; a start position of a time window of a resource set; a reference time slot of resources in a resource set; a time-frequency position of resources in a resource set; or a resource set type; a re-evaluated resource; or a re-preempted resource.

In this embodiment, the to-be-transmitted information received by the management entity may also include one or more of a resource pool corresponding to a resource set, a bandwidth part corresponding to a resource set, a start position of a time window of a resource set, a reference slot of resources in a resource set, a time-frequency position of resources in a resource set, a resource set type, a re-evaluated resource, and a re-preempted resource ry.

In an embodiment, the to-be-transmitted information includes a first candidate resource set and an NR unavailable resource set, where the first candidate resource set is acquired by a first module of the user equipment, and the NR unavailable resource set is acquired by a second module of the user equipment.

In an embodiment, the to-be-transmitted information includes a set acquired by excluding, in an NR perception process, resources overlapping with an NR unavailable resource set, where the set acquired by excluding, in the NR perception process, resources overlapping with the NR unavailable resource set is acquired by a first module of the user equipment, and the NR unavailable resource set is acquired by a second module of the user equipment.

In an embodiment, the to-be-transmitted information includes an NR unavailable resource set acquired by the user equipment or a second module of the user equipment.

In an embodiment, the to-be-transmitted information includes a first candidate resource set and an NR unavailable resource set, where the first candidate resource set is acquired by the user equipment, and the NR unavailable resource set is acquired by the user equipment.

In an embodiment, the to-be-transmitted information includes a set acquired by excluding, in an NR perception process, resources overlapping with an NR unavailable resource set, where the set acquired by excluding, in the NR perception process, the resources overlapping with the NR unavailable resource set and the NR unavailable resource set are acquired by the user equipment.

In an embodiment, the to-be-transmitted information includes a first candidate resource set and an available resource set, where the first candidate resource set is acquired by a first module of the user equipment, and the available resource set is acquired by a second module of the user equipment.

In an embodiment, the to-be-transmitted information includes the intersection of a candidate resource set acquired in an NR perception process and an available resource set, where the intersection of the candidate resource set acquired in the NR perception process and the available resource set is acquired by a first module of the user equipment, and the available resource set is acquired by a second module of the user equipment.

In an embodiment, the to-be-transmitted information includes an available resource set acquired by the user equipment or a second module of the user equipment.

In an embodiment, the to-be-transmitted information includes a first candidate resource set and an available resource set, where the first candidate resource set is acquired by the user equipment, and the available resource set is acquired by the user equipment.

In an embodiment, the to-be-transmitted information includes a set acquired by excluding, through the NR perception process, unavailable resources from a first initial set, where the available resource set is used as the first initial set.

The available resource set is used as the first initial set, and the set acquired by excluding, through the NR perception process, the unavailable resources from the first initial set is acquired by a first module of the user equipment, and the available resource set is acquired by a second module of the user equipment.

In an embodiment, the to-be-transmitted information includes a set acquired by excluding, through the NR perception process, unavailable resources from a second initial set, where the intersection of a set of all candidate resources determined according to a resource selection window and the available resource set is used as the second initial set.

The intersection of the set of all candidate resources determined according to the resource selection window and the available resource set is used as the second initial set, and the set acquired by excluding, through the NR perception process, the unavailable resources from the second initial set is acquired by a first module of the user equipment, and the available resource set is acquired by a second module of the user equipment.

In an embodiment, in the case where the allocated or reserved resource of the user equipment meets one or more of following conditions, conflict exists on the allocated or reserved resource:

The allocated or reserved resource overlaps with a reserved resource indicated by sidelink control information received by the user equipment.

The allocated or reserved resource overlaps with a reserved resource indicated by sidelink control information received by the user equipment, and the transmission priority of the user equipment on the allocated or reserved resource is lower than the transmission priority indicated by sidelink indication information.

The allocated or reserved resource overlaps with a reserved resource indicated by sidelink control information received by the user equipment, and RSRP corresponding to a PSCCH that corresponds to the sidelink control information or RSRP corresponding to a PSSCH that corresponds to the sidelink control information is greater than a second RSRP threshold.

The allocated or reserved resource overlaps with a reserved resource indicated by sidelink control information received by the user equipment, and the user equipment is a target receiving terminal of a transmission block sent on the reserved resource indicated by the sidelink control information.

The target receiving terminal of a transmission block sent on the allocated reserved resource processes a sleep state of DRX.

The user equipment cannot use the allocated or reserved resource due to the limitation of the transmission capability.

The allocated or reserved resource cannot be used due to the limitation of half-duplex.

The transmission method on the management entity side is exemplarily described below by different embodiments. It should be noted that for technical details not described in detail in this embodiment, reference may be made to any one of the preceding embodiments.

The management entity receives at least one of the following information (the information received by the management entity is the to-be-transmitted information transmitted by the UE): resource set or conflict information. The management entity allocates a resource to the UE based on the received information.

The resource set includes at least one of the following: NR candidate resource set, NR unavailable resource set, or available resource set. The NR candidate resource set may include one of the following: a first candidate resource set or a second candidate resource set. The first candidate resource set is a resource set acquired by the UE through an NR perception process. The second candidate resource set is one of the following: a resource set acquired by the UE by excluding, in the NR perception process, resources overlapping with the NR unavailable resource set, a resource set acquired by the UE taking the intersection of a candidate resource set acquired through the NR perception process and an available resource set; a resource set acquired by the UE through the NR perception process using the available resource set as an initial candidate resource set; or a candidate resource set acquired by the UE through the NR perception process using the intersection of an initial candidate resource set determined according to a resource selection window and the available resource set as the initial candidate resource set. The NR unavailable resource set is a set of resources that are reserved for LTE SL or cannot be used by the UE for a capability reason. The available resource set is the candidate resource set acquired by the UE through the LTE perception process. The conflict information indicates a conflict resource in the resources allocated to the UE.

The management entity may select a resource for the UE based on the received information (that is, the to-be-transmitted information).

In an embodiment, the information (that is, the to-be-transmitted information acquired by the management entity) received by a higher layer (that is, the management entity) includes a first candidate resource set and an NR unavailable resource set, and the higher layer selects a resource according to the first candidate resource set and the NR unavailable resource set. The first candidate resource set is a candidate resource set acquired by the first module of the UE through the NR perception process.

An example is used where the NR unavailable resource set includes an LTE SL reserved resource. The first module and the second module of the UE are the NR SL module and the LTE SL module, respectively. The NR SL module acquires a candidate resource set SA through the NR perception process and provides SA to a higher layer. The LTE SL module acquires an LTE SL reserved resource set Sc according to the monitored LTE SL SCI and/or the reserved resources of the LTE SL module. The LTE SL module provides Sc to the NR SL module, and the NR SL module provides Sc to the higher layer. Alternatively, the LTE SL module directly provides Sc to the higher layer, and the higher layer excludes resources overlapping with Sc from SA and then selects a resource for the NR SL module from the remaining resources for NR SL transmission to avoid resource conflict with LTE SL. It should be noted that if the number of remaining resources is less than the threshold X·Mₜₒₜₐₗ after the resources overlapping with Sc are excluded from SA, the higher layer decides whether to use the resources in Sc.

In an embodiment, the information received by the higher layer includes a second candidate resource set, and the higher layer selects a resource according to the second NR candidate resource set. The second candidate resource set is a candidate resource set acquired by the first module of the UE by excluding, through the NR perception process, resources overlapping with the NR unavailable resource set.

An example is used where the NR unavailable resource set includes an LTE SL reserved resource. The first module and the second module of the UE are the NR SL module and the LTE SL module, respectively. The LTE SL module acquires an LTE SL reserved resource set Sc according to the monitored LTE SL SCI and/or the reserved resources of the LTE SL module and provides Sc to the NR SL module. The NR SL module acquires a candidate resource set SB by excluding, through the NR perception process, resources overlapping with Sc and provides SB to the higher layer. The higher layer selects a resource for the NR SL module from SB for NR SL transmission to avoid resource conflict with LTE SL.

In an embodiment, the information received by a higher layer includes an NR unavailable resource set. The higher layer selects a resource according to the NR unavailable resource set.

An example is used where the NR unavailable resource set includes an LTE SL reserved resource. The UE or the LTE SL module (the second module) of the UE acquires an LTE SL reserved resource set Sc according to the monitored LTE SL SCI and/or the reserved resources of the UE or the LTE SL module of the UE and provides Sc to a higher layer. When the UE includes an LTE SL module and an NR SL module, the LTE SL module provides Sc to the NR SL module, and the NR SL module provides Sc to the higher layer. Alternatively, the LTE SL module directly provides Sc to the higher layer. When selecting a resource for the UE, the higher layer does not select a resource overlapping with Sc. If the number of remaining resources is less than the threshold X·Mₜₒₜₐₗ after the resources overlapping with Sc are excluded, the UE or the higher layer decides whether to use the resources in Sc.

In an embodiment, the information received by a higher layer includes a first candidate resource set and an NR unavailable resource set, and the higher layer selects a resource according to the first candidate resource set and the NR unavailable resource set. The first candidate resource set is a candidate resource set acquired by the UE through the NR perception process.

An example is used where the NR unavailable resource set includes an LTE SL reserved resource. The UE acquires a candidate resource set SA through the NR perception process and acquires an LTE SL reserved resource set Sc according to the monitored LTE SL SCI and/or the reserved resources of the UE. The UE provides SA and Sc to a higher layer. The higher layer excludes the resources overlapping with Sc from SA and then selects a resource for the NR SL module from the remaining resources for NR SL transmission to avoid resource conflict with LTE SL. It should be noted that if the number of remaining resources is less than the threshold X. Mₜₒₜₐₗ after the resources overlapping with Sc are excluded from SA, the UE or the higher layer decides whether to use the resources in Sc.

In an embodiment, for a scenario where LTE SL and NR SL coexist, a higher layer provides the UE with a percentage of the number of resources in a candidate resource set reported to the higher layer to the total number of initial candidate resources in a resource selection window or a ratio converted from the percentage.

In an embodiment, for a scenario where LTE SL and NR SL coexist, a higher layer provides the UE with a percentage X of the number of resources in a candidate resource set reported to the higher layer to the total number of initial candidate resources in a resource selection window or a ratio converted from the percentage. If the UE is not provided with X for a scenario where LTE SL and NR SL coexist, X corresponding to a scenario where LTE SL and NR SL do not coexist is applied to the scenario where LTE SL and NR SL coexist.

In an embodiment, the information received by a higher layer includes a second candidate resource set, and the higher layer selects a resource according to the second candidate resource set. The second candidate resource set is a candidate resource set acquired by the UE by excluding, through the NR perception process, resources overlapping with the NR unavailable resource set.

An example is used where the NR unavailable resource set includes an LTE SL reserved resource. The UE acquires an LTE SL reserved resource set Sc according to the monitored LTE SL SCI and/or the reserved resources of the UE. The UE excludes resources overlapping with Sc through the NR perception process, thereby acquiring an NR candidate resource set SB. The higher layer selects a resource based on SB.

In an embodiment, an LTE SL reserved resource includes at least one of the following: a reserved resource for another LTE SL UE or a reserved resource for the second module.

In an embodiment, the information received by a higher layer includes a first candidate resource set, and the higher layer selects a resource according to the first candidate resource set. The first candidate resource set is a candidate resource set acquired by the UE through the NR perception process.

For example, SL resources of the NR UE are scheduled by a base station (a higher layer) (that is, the resource allocation mode adopted by the UE is mode 1). The UE acquires a candidate resource set SA through the NR perception process and provides SA to the base station. The base station selects a resource for the UE based on SA to avoid resource conflict with the UE of NR mode 2.

In an embodiment, the information received by a higher layer includes a first candidate resource set and an available resource set, and the higher layer selects a resource according to the received information. The first candidate resource set is a candidate resource set acquired by the first module of the UE through the NR perception process. The available resource set is a candidate resource set acquired by the second module of the UE through the LTE perception process.

For example, the first candidate resource set and the available resource set are SA and SD, respectively, and the higher layer selects a resource from the intersection of SA and Sp to avoid resource conflict with LTE SL. If the number of resources in the intersection of SA and Sp is less than the threshold X·Mₜₒₜₐₗ, whether to select a resource from SA or from the intersection depends on the implementation (that is, whether to use a resource outside SD depends on the implementation).

In an embodiment, the information received by a higher layer includes a second candidate resource set, and the higher layer selects a resource according to the second candidate resource set. The second candidate resource set is the intersection of a candidate resource set acquired by the first module of the UE through the NR perception process and an available resource set. The available resource set is the candidate resource set acquired by the second module of the UE through the LTE perception process.

For example, the higher layer selects a resource for the NR SL module from the second candidate resource set. In this embodiment, the second candidate resource set may also be a candidate resource set acquired by the first module through the NR perception process using the available resource set Sp as the initial candidate resource set; or the second candidate resource set may also be a candidate resource set acquired by the first module through the NR perception process using the intersection of an initial candidate resource set determined according to a resource selection window and the available resource set as the initial candidate resource set.

In an embodiment, the information received by a higher layer includes an available resource set. The higher layer selects a resource according to the available resource set.

For example, the available resource set is SD. The higher layer selects a resource from Sp when selecting a resource for the UE. If the UE has a function of perception and provides a candidate resource set acquired through the perception process to the higher layer, whether the higher layer selects a resource from Sp or SA is implementation dependent.

In an embodiment, the information received by a higher layer includes a first candidate resource set and an available resource set, and the higher layer selects a resource according to the received information. The first candidate resource set is a candidate resource set acquired by the UE through the NR perception process. The available resource set is a candidate resource set acquired by the UE through the LTE perception process.

For example, the first candidate resource set and the available resource set are SA and SD, respectively, and the higher layer selects a resource from the intersection of SA and Sp to avoid resource conflict with LTE SL. It should be noted that if the number of resources in the intersection of SA and Sp is less than the threshold X·Mₜₒₜₐₗ, whether to select a resource from SA or from the intersection is implementation dependent.

In an embodiment, the information received by a higher layer includes a second candidate resource set, and the higher layer selects a resource according to the received information. The second candidate resource set is the intersection of a candidate resource set acquired by the UE through the NR perception process and an available resource set. The available resource set is the candidate resource set acquired by the UE through the LTE perception process.

For example, the second candidate resource set is SB, and the higher layer selects a resource from SB to allocate to the UE. In this embodiment, the second candidate resource set may also be a candidate resource set acquired by the UE through the NR perception process using the available resource set Sp as an initial candidate resource set; or the second candidate resource set may also be a candidate resource set acquired by the UE through the NR perception process using the intersection of an initial candidate resource set determined according to a resource selection window and an available resource set as the initial candidate resource set.

In an embodiment, the information received by a higher layer includes a second candidate resource set, and the higher layer selects a resource according to the received information. The second candidate resource set is a candidate resource set acquired by the first module of the UE by excluding, through the NR perception process, resources overlapping with the NR unavailable resource set. The NR unavailable resource set is acquired by the second module of the UE and then provided to a higher layer of the first module, and the higher layer of the first module then provides the NR unavailable resource set to a physical layer of the first module.

For example, the second candidate resource set is SB, and the higher layer selects a resource from SB to allocate to the UE.

In an embodiment, the information received by a higher layer includes a second candidate resource set, and the higher layer selects a resource according to the received information. The second candidate resource set is the intersection of a candidate resource set acquired by the first module of the UE through the NR perception process and an available resource set. The available resource set is acquired by the second module of the UE and then provided to the higher layer of the first module, and the higher layer of the first module then provides the available resource set to a physical layer of the first module.

For example, the second module (LTE SL module) acquires a candidate resource set (that is, the available resource set) Sp through the LTE perception process and provides Sp to the higher layer of the first module (NR SL module). The higher layer of the first module provides SD to the physical layer of the first module, and the physical layer of the first module takes the intersection of the candidate resource set acquired through the NR perception process and Sp to obtain a second candidate resource set SB and reports the second candidate resource set SB to the higher layer. The higher layer selects a resource from SB and allocates SB to the UE. In this embodiment, the second candidate resource set may also be a candidate resource set acquired by the first module through the NR perception process using the available resource set Sp as the initial candidate resource set.

In an embodiment, the information received by a higher layer includes a second candidate resource set, and the higher layer selects a resource according to the received information. The second candidate resource set is a candidate resource set acquired by the first module through the NR perception process using an available resource set as the initial candidate resource set. The available resource set is acquired by the second module of the UE and then provided to the higher layer of the first module, and the higher layer of the first module then provides the available resource set to a physical layer of the first module.

In an embodiment, the information received by a higher layer includes a second candidate resource set, and the higher layer selects a resource according to the received information. The second candidate resource set is a candidate resource set acquired by the first module of the UE through the NR perception process using the intersection of an initial candidate resource set determined according to a resource selection window and an available resource set as the initial candidate resource set. The available resource set is acquired by the second module of the UE and then provided to the higher layer of the first module, and the higher layer of the first module then provides the available resource set to a physical layer of the first module.

In an embodiment, if the information received by a higher layer includes conflict information, the higher layer performs resource re-selection.

For example, if the information received by the higher layer from the UE includes conflict information, the higher layer re-allocates a resource for the UE or the first module of the UE.

In an embodiment, the higher layer includes one of the following: a higher layer of the UE, a higher layer of a first module, a higher layer of a second module, an NR base station, or an NR network.

It should be noted that in all the preceding embodiments, if the NR unavailable resource set includes other resources in addition to the LTE SL reserved resource set, it is also necessary to exclude resources that overlap with other resources when a resource set is determined or a higher layer selects a resource.

In an embodiment, a higher layer provides a perception measurement configuration for the UE. The perception measurement configuration includes at least one of the following: NR perception measurement configuration or LTE perception measurement configuration.

In an embodiment, the higher layer also receives at least one of the following information: resource pool corresponding to a resource set, BWP corresponding to a resource set, start position of a time window for acquiring a resource set, reference time slot of resources in a resource set, time-frequency position of resources in a resource set, resource set type, re-evaluated resource rx, or re-preempted resource ry.

In an embodiment, the higher layer receives resource set information in time slot X. The conditions satisfied by time slot X refer to the preceding embodiments.

In an embodiment, the higher layer receives resource set information in time slot Y. The conditions satisfied by time slot Y refer to the preceding embodiments.

In an embodiment, the higher layer provides the value of Nx to the UE. The meaning of Nx refers to the preceding embodiments. It should be noted that Nx herein may be Tx in the preceding embodiments, and the reference may be made to the description of Tx in the preceding embodiments.

In an embodiment, the higher layer provides the UE with whether to receive indication information. Whether to receive indication information includes at least one of the following: whether to receive resource set information or whether to receive conflict information.

In an embodiment, the higher layer carries whether to receive indication information by one of the following: reserved field indication in DCI, indication by an MAC CE, or indication by higher-layer signaling.

It should be noted that whether to receive resource set information and whether to receive conflict information may be carried in different manners.

In an embodiment, the higher layer configures for each resource pool whether to enable the reporting of a resource set or reporting of conflict information.

In an embodiment, the higher layer configures for each resource pool whether to enable the reporting of one or some resource sets or reporting of conflict information.

Embodiments of the present application further provide a transmission apparatus. FIG. 3 is a diagram illustrating the structure of a transmission apparatus according to an embodiment. As shown in FIG. 3, the transmission apparatus may be configured in a user equipment and includes a determination module 310 and a transmission module 320.

The determination module 310 is configured to determine to-be-transmitted information, where the to-be-transmitted information indicates that a management entity selects a resource for the user equipment.

The transmission module 320 is configured to transmit the to-be-transmitted information to the management entity.

In the transmission apparatus of this embodiment, the UE side determines to-be-transmitted information and transmits the determined to-be-transmitted information to the management entity so that the management entity that receives the to-be-transmitted information can select, according to the to-be-transmitted information, an available SL transmission resource that does not have resource conflict for the UE. Thus, interference caused by resource coexistence can be avoided, and SL communication can coexist in the same frequency resource.

In an embodiment, the to-be-transmitted information includes conflict information, and the conflict information indicates a conflict resource in an allocated or reserved resource.

In an embodiment, the to-be-transmitted information includes a resource set, and the resource set includes one or more of the following: an NR candidate resource set; an NR unavailable resource set, where the NR unavailable resource set is a set of resources that are reserved for SL of LTE or cannot be used by the user equipment for a capability reason; or an available resource set, where the available resource set is a candidate resource set acquired by the user equipment through an LTE perception process.

In an embodiment, the NR candidate resource set includes one or more of the following: a first candidate resource set acquired through an NR perception process; or a second candidate resource set.

In an embodiment, the second candidate resource set includes one or more of the following: a set acquired by excluding, in the NR perception process, resources overlapping with the NR unavailable resource set; the intersection of the candidate resource set acquired in the NR perception process and the available resource set; a set acquired by excluding, through the NR perception process, unavailable resources from a first initial set, where the available resource set is used as the first initial set; or a set acquired by excluding, through the NR perception process, unavailable resources from a second initial set, where the intersection of a set of all candidate resources determined according to a resource selection window and the available resource set is used as the second initial set.

The unavailable resources include one or more of the following: all possible reserved resources on an unmonitored slot; resources overlapping with resources reserved by sidelink control information corresponding to SL transmission whose RSRP measured in a monitored time slot is greater than a first RSRP threshold; or resources overlapping with the NR unavailable resource set.

In an embodiment, the NR unavailable resource set includes one or more of the following: a reserved resource for LTE SL transmission of other user equipments; a reserved resource for an LTE module of the user equipment; all resources on a slot on which a reserved resource for an LTE process of the user equipment is located; a resource unavailable to the user equipment due to exceeding the transmission capacity; or a resource unavailable to the user equipment due to the limitation of half-duplex.

In an embodiment, the to-be-transmitted information includes a first candidate resource set and an NR unavailable resource set, where the first candidate resource set is acquired by a first module of the user equipment, and the NR unavailable resource set is acquired by a second module of the user equipment.

In an embodiment, the to-be-transmitted information includes a set acquired by excluding, in an NR perception process, resources overlapping with an NR unavailable resource set, where the set acquired by excluding, in the NR perception process, resources overlapping with the NR unavailable resource set is acquired by a first module of the user equipment, and the NR unavailable resource set is acquired by a second module of the user equipment.

In an embodiment, the to-be-transmitted information includes an NR unavailable resource set acquired by the user equipment or a second module of the user equipment.

In an embodiment, the to-be-transmitted information includes a first candidate resource set and an NR unavailable resource set, where the first candidate resource set is acquired by the user equipment, and the NR unavailable resource set is acquired by the user equipment.

In an embodiment, the to-be-transmitted information includes a set acquired by excluding, in an NR perception process, resources overlapping with an NR unavailable resource set, where the set acquired by excluding, in the NR perception process, the resources overlapping with the NR unavailable resource set and the NR unavailable resource set are acquired by the user equipment.

In an embodiment, the to-be-transmitted information includes a first candidate resource set and an available resource set, where the first candidate resource set is acquired by a first module of the user equipment, and the available resource set is acquired by a second module of the user equipment.

In an embodiment, the to-be-transmitted information includes the intersection of a candidate resource set acquired in an NR perception process and an available resource set, where the intersection of the candidate resource set acquired in the NR perception process and the available resource set is acquired by a first module of the user equipment, and the available resource set is acquired by a second module of the user equipment.

In an embodiment, the to-be-transmitted information includes an available resource set acquired by the user equipment or a second module of the user equipment.

In an embodiment, the to-be-transmitted information includes a first candidate resource set and an available resource set, where the first candidate resource set is acquired by the user equipment, and the available resource set is acquired by the user equipment.

In an embodiment, the to-be-transmitted information includes a set acquired by excluding, through the NR perception process, unavailable resources from a first initial set, where the available resource set is used as the first initial set.

The available resource set is used as the first initial set, and the set acquired by excluding, through the NR perception process, the unavailable resources from the first initial set is acquired by a first module of the user equipment, and the available resource set is acquired by a second module of the user equipment.

In an embodiment, the to-be-transmitted information includes a set acquired by excluding, through the NR perception process, unavailable resources from a second initial set, where the intersection of a set of all candidate resources determined according to a resource selection window and the available resource set is used as the second initial set.

The intersection of the set of all candidate resources determined according to the resource selection window and the available resource set is used as the second initial set, and the set acquired by excluding, through the NR perception process, the unavailable resources from the second initial set is acquired by a first module of the user equipment, and the available resource set is acquired by a second module of the user equipment.

In an embodiment, in the case where the allocated or reserved resource of the user equipment meets one or more of following conditions, conflict exists on the allocated or reserved resource:

The allocated or reserved resource overlaps with a reserved resource indicated by sidelink control information received by the user equipment.

The allocated or reserved resource overlaps with a reserved resource indicated by sidelink control information received by the user equipment, and the transmission priority of the user equipment on the allocated or reserved resource is lower than the transmission priority indicated by sidelink indication information.

The allocated or reserved resource overlaps with a reserved resource indicated by sidelink control information received by the user equipment, and RSRP corresponding to a physical sidelink control channel that corresponds to the sidelink control information or RSRP corresponding to a physical sidelink shared channel that corresponds to the sidelink control information is greater than a second RSRP threshold.

The allocated or reserved resource overlaps with a reserved resource indicated by sidelink control information received by the user equipment, and the user equipment is a target receiving terminal of a transmission block sent on the reserved resource indicated by the sidelink control information.

The target receiving terminal of a transmission block sent on the allocated or reserved resource processes a sleep state of discontinuous reception.

The user equipment cannot use the allocated or reserved resource due to the limitation of the transmission capability.

The allocated or reserved resource cannot be used due to the limitation of half-duplex.

In an embodiment, the apparatus also includes an information transmission module.

The information transmission module is configured to transmit one or more of the following: a resource pool corresponding to a resource set; a bandwidth part corresponding to a resource set; a start position of a time window of a resource set; a reference time slot of resources in a resource set; a time-frequency position of resources in a resource set; or a resource set type.

The transmission apparatus provided in this embodiment and the transmission method provided in the preceding embodiments belong to the same concept. For technical details not described in detail in this embodiment, reference may be made to any one of the preceding embodiments. The embodiment has the same beneficial effects as the applied transmission method.

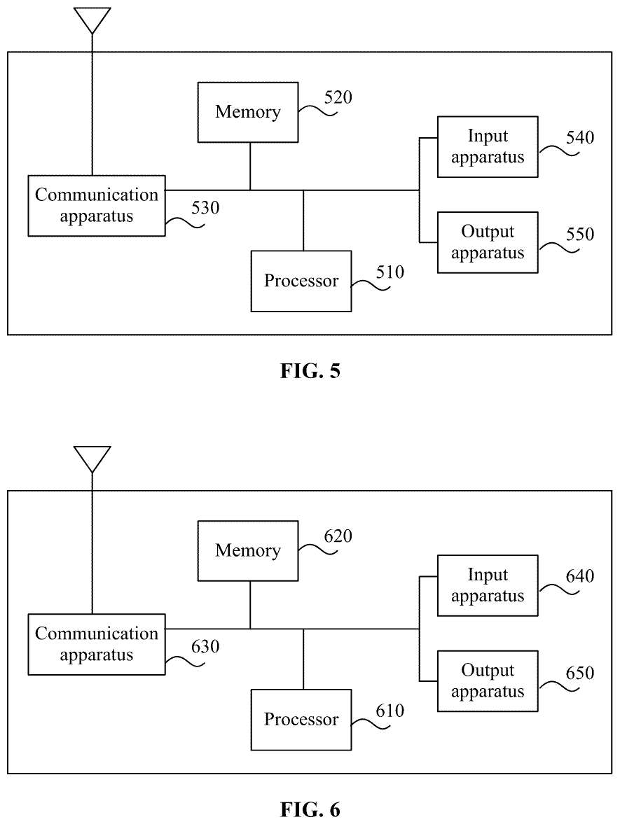

Embodiments of the present application also provide a transmission apparatus. FIG. 4 is a diagram illustrating the structure of a transmission apparatus according to an embodiment. As shown in FIG. 4, the transmission apparatus may be configured in a management entity and includes an acquisition module 410 and a selection module 420.

The acquisition module 410 is configured to acquire to-be-transmitted information, where the to-be-transmitted information indicates that the management entity selects a resource for a user equipment.

The selection module 420 is configured to select the resource based on the to-be-transmitted information.

In the transmission apparatus of this embodiment, the management entity selects a resource based on the acquired to-be-transmitted information to allocate an available resource to the UE without causing resource conflict, thereby achieving coexistence of SL communication within the same frequency resource and avoiding resource conflict that exists when resources coexist.

In an embodiment, the to-be-transmitted information includes conflict information, and the conflict information indicates a conflict resource in an allocated or reserved resource.

In an embodiment, the to-be-transmitted information includes a resource set, and the resource set includes one or more of the following: an NR candidate resource set; an NR unavailable resource set, where the NR unavailable resource set is a set of resources that are reserved for SL of LTE or cannot be used by the user equipment for a capability reason; or an available resource set, where the available resource set is a candidate resource set acquired by the user equipment through an LTE perception process.

In an embodiment, the NR candidate resource set includes one or more of the following: a first candidate resource set acquired by the UE through an NR perception process; or a second candidate resource set.

In an embodiment, the second candidate resource set includes one or more of the following: a set acquired by excluding, in the NR perception process, resources overlapping with the NR unavailable resource set; the intersection of the candidate resource set acquired in the NR perception process and the available resource set; a set acquired by excluding, through the NR perception process, unavailable resources from a first initial set, where the available resource set is used as the first initial set; or a set acquired by excluding, through the NR perception process, unavailable resources from a second initial set, where the intersection of a set of all candidate resources determined according to a resource selection window and the available resource set is used as the second initial set.

The unavailable resources include one or more of the following: all possible reserved resources on an unmonitored slot; resources overlapping with resources reserved by sidelink control information corresponding to SL transmission whose RSRP measured in a monitored time slot is greater than a first RSRP threshold; or resources overlapping with the NR unavailable resource set.

In an embodiment, the apparatus also includes a receiving apparatus.

The receiving apparatus is configured to receive one or more of the following: a resource pool corresponding to a resource set; a bandwidth part corresponding to a resource set; a start position of a time window of a resource set; a reference time slot of resources in a resource set; a time-frequency position of resources in a resource set; or a resource set type; a re-evaluated resource; or a re-preempted resource.

In an embodiment, the to-be-transmitted information includes a first candidate resource set and an NR unavailable resource set, where the first candidate resource set is acquired by a first module of the user equipment, and the NR unavailable resource set is acquired by a second module of the user equipment.

In an embodiment, the to-be-transmitted information includes a set acquired by excluding, in an NR perception process, resources overlapping with an NR unavailable resource set, where the set acquired by excluding, in the NR perception process, resources overlapping with the NR unavailable resource set is acquired by a first module of the user equipment, and the NR unavailable resource set is acquired by a second module of the user equipment.

In an embodiment, the to-be-transmitted information includes an NR unavailable resource set acquired by the user equipment or a second module of the user equipment.

In an embodiment, the to-be-transmitted information includes a first candidate resource set and an NR unavailable resource set, where the first candidate resource set is acquired by the user equipment, and the NR unavailable resource set is acquired by the user equipment.

In an embodiment, the to-be-transmitted information includes a set acquired by excluding, in an NR perception process, resources overlapping with an NR unavailable resource set, where the set acquired by excluding, in the NR perception process, the resources overlapping with the NR unavailable resource set and the NR unavailable resource set are acquired by the user equipment.

In an embodiment, the to-be-transmitted information includes a first candidate resource set and an available resource set, where the first candidate resource set is acquired by a first module of the user equipment, and the available resource set is acquired by a second module of the user equipment.

In an embodiment, the to-be-transmitted information includes the intersection of a candidate resource set acquired in an NR perception process and an available resource set, where the intersection of the candidate resource set acquired in the NR perception process and the available resource set is acquired by a first module of the user equipment, and the available resource set is acquired by a second module of the user equipment.

In an embodiment, the to-be-transmitted information includes an available resource set acquired by the user equipment or a second module of the user equipment.

In an embodiment, the to-be-transmitted information includes a first candidate resource set and an available resource set, where the first candidate resource set is acquired by the user equipment, and the available resource set is acquired by the user equipment.

In an embodiment, the to-be-transmitted information includes a set acquired by excluding, through the NR perception process, unavailable resources from a first initial set, where the available resource set is used as the first initial set.

The available resource set is used as the first initial set, and the set acquired by excluding, through the NR perception process, the unavailable resources from the first initial set is acquired by a first module of the user equipment, and the available resource set is acquired by a second module of the user equipment.

In an embodiment, the to-be-transmitted information includes a set acquired by excluding, through the NR perception process, unavailable resources from a second initial set, where the intersection of a set of all candidate resources determined according to a resource selection window and the available resource set is used as the second initial set.

The intersection of the set of all candidate resources determined according to the resource selection window and the available resource set is used as the second initial set, and the set acquired by excluding, through the NR perception process, the unavailable resources from the second initial set is acquired by a first module of the user equipment, and the available resource set is acquired by a second module of the user equipment.

In an embodiment, in the case where the allocated or reserved resource of the user equipment meets one or more of following conditions, conflict exists on the allocated or reserved resource:

The allocated or reserved resource overlaps with a reserved resource indicated by sidelink control information received by the user equipment.

The allocated or reserved resource overlaps with a reserved resource indicated by sidelink control information received by the user equipment, and the transmission priority of the user equipment on the allocated or reserved resource is lower than the transmission priority indicated by sidelink indication information.

The allocated or reserved resource overlaps with a reserved resource indicated by sidelink control information received by the user equipment, and RSRP corresponding to a PSCCH that corresponds to the sidelink control information or RSRP corresponding to a PSSCH that corresponds to the sidelink control information is greater than a second RSRP threshold.

The allocated or reserved resource overlaps with a reserved resource indicated by sidelink control information received by the user equipment, and the user equipment is a target receiving terminal of a transmission block sent on the reserved resource indicated by the sidelink control information.

The target receiving terminal of a transmission block sent on the allocated reserved resource processes a sleep state of DRX.

The user equipment cannot use the allocated or reserved resource due to the limitation of the transmission capability.

The allocated or reserved resource cannot be used due to the limitation of half-duplex.

The transmission apparatus provided in this embodiment and the transmission method provided in the preceding embodiments belong to the same concept. For technical details not described in detail in this embodiment, reference may be made to any one of the preceding embodiments. The embodiment has the same beneficial effects as the applied transmission method.

In an embodiment, the NR unavailable resource set is acquired by the second module of the user equipment, which generally indicates that the reserved resources for LTE SL transmission of other user equipments in the NR unavailable resource set and the reserved resources for the LTE module of the user equipment are acquired by the second module of the user equipment; other resources (for example, other resources may be all resources on a time slot where the reserved resources for the LTE process of the user equipment are located, resources that the user equipment cannot use due to exceeding the transmission capacity, and/or resources that the user equipment cannot use due to the limitation of half-duplex) may be acquired by the second module of the UE, the first module of the UE, or the UE. The acquisition entity of other resources is not limited in this embodiment.

An embodiment of the present application also provides a user equipment. FIG. 5 is a diagram illustrating the hardware structure of a user equipment according to an embodiment. As shown in FIG. 5, the user equipment provided by this application includes a memory 520, a processor 510, and a computer program stored on the memory and executable on the processor. The processor 510, when executing the program, implements the preceding transmission method.

The user equipment may also include the memory 520. One or more processors 510 may be provided in the user equipment, and one processor 510 is used as an example in FIG. 5. The memory 520 is configured to store one or more programs. When executed by the one or more processors 510, the one or more programs cause the one or more processors 510 to implement the transmission method described in the embodiments of the present application.

The user equipment also includes a communication apparatus 530, an input apparatus 540, and an output apparatus 550.

The one or more processors 510, the memory 520, the communication apparatus 530, the input apparatus 540, and the output apparatus 550 that are in the user equipment may be connected through a bus or in other manners. In FIG. 5, the connection through the bus is taken as an example.

The input apparatus 540 may be used for receiving inputted digital or character information and for generating key signal input related to user settings and function control of the user equipment. The output apparatus 550 may include a display device such as a display screen.

The communication apparatus 530 may include a receiver and a sender. The communication apparatus 530 is configured to perform information transceiving and communication under the control of the one or more processors 510.

As a computer-readable storage medium, the memory 520 may be configured to store software programs, computer-executable programs, and modules, such as program instructions/modules (for example, the determination module 310 and the transmission module 320 that are in the transmission apparatus) corresponding to the transmission method according to embodiments of the present application. The memory 520 may include a program storage region and a data storage region. The program storage region may store an operating system and an application program required by at least one function. The data storage region may store data created depending on use of a user equipment. In addition, the memory 520 may include a high-speed random-access memory and a nonvolatile memory, such as at least one disk memory, a flash memory, or other nonvolatile solid-state memories. In some examples, the memory 520 may also include memories located remotely relative to the processor 510, and these remote memories may be connected to the device via a network. Examples of the preceding network include but are not limited to, the Internet, an intranet, a local area network, a mobile communication network, and a combination thereof.

An embodiment of the present application also provides a management entity. FIG. 6 is a diagram illustrating the hardware structure of a management entity according to an embodiment. As shown in FIG. 6, the management entity provided by this application includes a memory 620, a processor 610, and a computer program stored on the memory and executable on the processor. The processor 610, when executing the program, implements the preceding transmission method.

The management entity may also include the memory 620. One or more processors 610 may be provided in the management entity, and one processor 610 is used as an example in FIG. 6. The memory 620 is configured to store one or more programs. When executed by the one or more processors 610, the one or more programs cause the one or more processors 610 to implement the transmission method described in the embodiments of the present application.

The management entity also includes a communication apparatus 630, an input apparatus 640, and an output apparatus 650.

The processor 610, the memory 620, the communication apparatus 630, the input apparatus 640, and the output apparatus 650 in the management entity may be connected through a bus or in other manners. In FIG. 6, connection through a bus is performed by way of example.

The input apparatus 640 may be used for receiving inputted digital or character information and for generating key signal input related to user settings and function control of the management entity. The output apparatus 650 may include a display device such as a display screen.

The communication apparatus 630 may include a receiver and a sender. The communication apparatus 630 is configured to perform information transceiving and communication under the control of the one or more processors 610.

As a computer-readable storage medium, the memory 620 may be configured to store software programs, computer-executable programs, and modules, such as program instructions/modules (for example, the acquisition module 410 and the selection module 420 that are in the transmission apparatus) corresponding to the transmission method according to embodiments of the present application. The memory 620 may include a program storage region and a data storage region. The program storage region may store an operating system and an application program required by at least one function. The data storage region may store data created according to the use of the management entity. In addition, the memory 620 may include a high-speed random-access memory and a nonvolatile memory, such as at least one disk memory, a flash memory, or other nonvolatile solid-state memories. In some examples, the memory 620 may also include memories located remotely relative to the processor 610, and these remote memories may be connected to the management entity via a network. Examples of the preceding network include but are not limited to, the Internet, an intranet, a local area network, a mobile communication network, and a combination thereof.

An embodiment of the present application provides a storage medium. The storage medium stores a computer program that, when executed by a processor, causes the processor to perform the transmission method according to any embodiment of the present application.

For example, the transmission method is applied to a user equipment and includes the following: To-be-transmitted information is determined, where the to-be-transmitted information indicates that a management entity selects a resource for the user equipment; and the to-be-transmitted information is transmitted to the management entity.

For example, the transmission method is applied to a management entity and includes the following: To-be-transmitted information is acquired, where the to-be-transmitted information indicates that the management entity selects a resource for a user equipment; and the resource is selected based on the to-be-transmitted information.

A computer storage medium in this embodiment of the present application may adopt any combination of one or more computer-readable media. The computer-readable medium may be a computer-readable signal medium or a computer-readable storage medium. The computer-readable storage medium may be, for example, but is not limited to, an electrical, magnetic, optical, electromagnetic, infrared, or semiconductor system, apparatus, or device, or any combination thereof. Examples (a non-exhaustive list) of the computer-readable storage medium include an electrical connection having one or more wires, a portable computer magnetic disk, a hard disk, a random-access memory (RAM), a read-only memory (ROM), an erasable programmable read-only memory (EPROM), a flash memory, an optical fiber, a portable compact disc read-only memory (CD-ROM), an optical memory device, a magnetic memory device, or any suitable combination thereof. The computer-readable storage medium may be any tangible medium including or storing a program. The program may be used by or used in conjunction with an instruction execution system, apparatus, or device.

The computer-readable signal medium may include a data signal propagated in a baseband or as part of a carrier. The data signal carries computer-readable program codes. The data signal propagated in this manner may be in multiple forms and includes, but is not limited to, an electromagnetic signal, an optical signal, or any suitable combination thereof. The computer-readable signal medium may also be any computer-readable medium other than the computer-readable storage medium. The computer-readable medium may send, propagate, or transmit a program used by or used in conjunction with an instruction execution system, apparatus, or device.

The program codes included on the computer-readable medium may be transmitted on any suitable medium including, but not limited to, a wireless medium, a wire, an optical cable, a radio frequency (RF), or any suitable combination thereof.

Computer program codes for performing the operations of the present application may be written in one or more programming languages or a combination of multiple programming languages. The programming languages include object-oriented programming languages such as Java, Smalltalk, and C++ and may also include conventional procedural programming languages such as “C” or similar programming languages. The program codes may be executed entirely on a user computer, partly on a user computer, as a stand-alone software package, partly on a user computer and partly on a remote computer, or entirely on a remote computer or a server. In a case related to the remote computer, the remote computer may be connected to the user computer via any type of network including a local area network (LAN) or a wide area network (WAN) or may be connected to an external computer (for example, via the Internet by an Internet service provider).

The preceding content is only example embodiments of the present application and not intended to limit the scope of the present application.

It is to be understood by those skilled in the art that the term user terminal encompasses any suitable type of wireless user device, for example, a mobile phone, a portable data processing apparatus, a portable web browser, or a vehicle-mounted mobile station.

Generally speaking, various embodiments of the present application may be implemented in hardware or special-purpose circuits, software, logic, or any combination thereof. For example, some aspects may be implemented in hardware while other aspects may be implemented in firmware or software executable by a controller, a microprocessor, or another calculation apparatus, though the present application is not limited thereto.

Embodiments of the present application may be implemented through the execution of computer program instructions by a data processor of a mobile apparatus, for example, implemented in a processor entity, by hardware, or by a combination of software and hardware. The computer program instructions may be assembly instructions, instruction set architecture (ISA) instructions, machine instructions, machine-related instructions, microcodes, firmware instructions, state setting data, or source or object codes written in any combination of one or more programming languages.

A block diagram of any logic flow among the drawings of the present application may represent program procedures, may represent interconnected logic circuits, modules, and functions, or may represent a combination of program procedures with logic circuits, modules, and functions. Computer programs may be stored in a memory. The memory may be of any type suitable for a local technical environment and may be implemented using any suitable data storage technology such as, but not limited to, a read-only memory (ROM), a random-access memory (RAM), or an optical memory device and system (a digital video disc (DVD), or a compact disc (CD)). Computer-readable media may include non-transitory storage media. The data processor may be of any type suitable for a local technical environment, such as, but not limited to, a general-purpose computer, a special-purpose computer, a microprocessor, a digital signal processor (DSP), an application-specific integrated circuit (ASIC), a field-programmable gate array (FPGA), and a processor based on a multi-core processor architecture.

The detailed description of example embodiments of the present application has been provided above through exemplary and non-restrictive examples. However, considering the drawings and the claims, various modifications and adjustments to the preceding embodiments are apparent to those skilled in the art without deviating from the scope of the present application. Accordingly, the proper scope of the present application is determined according to the claims.

1. A transmission method, the method being applied to a user equipment and comprising:
determining to-be-transmitted information, wherein the to-be-transmitted information indicates that a management entity selects a resource for the user equipment; and
transmitting the to-be-transmitted information to the management entity.

2. The method of claim 1, wherein the to-be-transmitted information comprises conflict information, and the conflict information indicates a resource on which conflict exists in an allocated or reserved resource.

3. The method of claim 1, wherein the to-be-transmitted information comprises a resource set, and the resource set comprises one or more of the following:
a New Radio (NR) candidate resource set;
an NR unavailable resource set, wherein the NR unavailable resource set is a set of resources that are reserved for sidelink (SL) of Long-Term Evolution (LTE) or unavailable to the user equipment for a capability reason; or
an available resource set, wherein the available resource set is a candidate resource set acquired by the user equipment through an LTE perception process.

4. The method of claim 3, wherein the NR candidate resource set comprises one or more of the following:
a first candidate resource set acquired through an NR perception process; or
a second candidate resource set.

5. The method of claim 4, wherein the second candidate resource set comprises one or more of the following:
a set acquired by excluding, in the NR perception process, resources overlapping with the NR unavailable resource set;
an intersection of the candidate resource set acquired in the NR perception process and the available resource set;
a set acquired by excluding, through the NR perception process, unavailable resources from a first initial set, wherein the available resource set is used as the first initial set; or
a set acquired by excluding, through the NR perception process, unavailable resources from a second initial set, wherein an intersection of a set of all candidate resources determined according to a resource selection window and the available resource set is used as the second initial set;
wherein the unavailable resources comprise one or more of the following: all possible reserved resources on an unmonitored slot; resources overlapping with resources reserved by sidelink control information corresponding to SL transmission whose reference signal received power (RSRP) measured in a monitored time slot is greater than a first RSRP threshold; or
resources overlapping with the NR unavailable resource set.

6. The method of claim 3, wherein the NR unavailable resource set comprises one or more of the following:
a reserved resource for LTE SL transmission of other user equipments;
a reserved resource for an LTE module of the user equipment;
all resources on a slot on which a reserved resource for an LTE SL process of the user equipment is located;
a resource unavailable to the user equipment due to exceeding a transmission capacity; or
a resource unavailable to the user equipment due to a limitation of half-duplex.

7. The method of claim 1, wherein the to-be-transmitted information comprises:
a first candidate resource set and an NR unavailable resource set, wherein the first candidate resource set is acquired by a first module of the user equipment, and the NR unavailable resource set is acquired by a second module of the user equipment.

8. The method of claim 1, wherein the to-be-transmitted information comprises:
a set acquired by excluding, in an NR perception process, resources overlapping with an NR unavailable resource set, wherein the set acquired by excluding, in the NR perception process, resources overlapping with the NR unavailable resource set is acquired by a first module of the user equipment, and the NR unavailable resource set is acquired by a second module of the user equipment.

9. The method of claim 1, wherein the to-be-transmitted information comprises:
an NR unavailable resource set, wherein the NR unavailable resource set is acquired by the user equipment or a second module of the user equipment;
a first candidate resource set and an NR unavailable resource set, wherein the first candidate resource set is acquired by the user equipment, and the NR unavailable resource set is acquired by the user equipment;
a set acquired by excluding, in an NR perception process, resources overlapping with an NR unavailable resource set, wherein the set acquired by excluding, in the NR perception process, the resources overlapping with the NR unavailable resource set and the NR unavailable resource set are acquired by the user equipment;
a first candidate resource set and an available resource set, wherein the first candidate resource set is acquired by a first module of the user equipment, and the available resource set is acquired by a second module of the user equipment;
an intersection of a candidate resource set acquired in an NR perception process and an available resource set, wherein the intersection of the candidate resource set acquired in the NR perception process and the available resource set is acquired by a first module of the user equipment, and the available resource set is acquired by a second module of the user equipment;
an available resource set, wherein the available resource set is acquired by the user equipment or a second module of the user equipment;
a first candidate resource set and an available resource set, wherein the first candidate resource set is acquired by the user equipment, and the available resource set is acquired by the user equipment;
a set acquired by excluding, through an NR perception process, unavailable resources from a first initial set, wherein an available resource set is used as the first initial set, and the set acquired by excluding, through the NR perception process, the unavailable resources from the first initial set is acquired by a first module of the user equipment, and the available resource set is acquired by a second module of the user equipment; or
a set acquired by excluding, through an NR perception process, unavailable resources from a second initial set, wherein an intersection of a set of all candidate resources determined according to a resource selection window and an available resource set is used as the second initial set, wherein the set acquired by excluding, through the NR perception process, the unavailable resources from the second initial set is acquired by a first module of the user equipment, and the available resource set is acquired by a second module of the user equipment.

10-17. (canceled)

18. The method of claim 2, wherein in a case where the allocated or reserved resource of the user equipment meets one or more of following conditions, conflict exists on the allocated or reserved resource:
the allocated or reserved resource overlaps with a reserved resource indicated by sidelink control information received by the user equipment;
the allocated or reserved resource overlaps with a reserved resource indicated by sidelink control information received by the user equipment, and a transmission priority of the user equipment on the allocated or reserved resource is lower than a transmission priority indicated by sidelink indication information;
the allocated or reserved resource overlaps with a reserved resource indicated by sidelink control information received by the user equipment, and RSRP corresponding to a physical sidelink control channel that corresponds to the sidelink control information or RSRP corresponding to a physical sidelink shared channel that corresponds to the sidelink control information is greater than a second RSRP threshold;
the allocated or reserved resource overlaps with a reserved resource indicated by sidelink control information received by the user equipment, and the user equipment is a target receiving terminal of a transmission block sent on the reserved resource indicated by the sidelink control information;
a target receiving terminal of a transmission block sent on the allocated or reserved resource processes a sleep state of discontinuous reception;
the user equipment is unable to use the allocated or reserved resource due to a limitation of a transmission capability; or
the allocated or reserved resource is unavailable due to a limitation of half-duplex.

19. The method of claim 1, further comprising: transmitting one or more of the following:
a resource pool corresponding to a resource set;
a bandwidth part corresponding to a resource set;
a start position of a time window of a resource set;
a reference time slot of resources in a resource set;
a time-frequency position of resources in a resource set; or
a resource set type.

20. A transmission method, the method being applied to a management entity and comprising:
acquiring to-be-transmitted information, wherein the to-be-transmitted information indicates that the management entity selects a resource for a user equipment; and
selecting the resource based on the to-be-transmitted information.

21. The method of claim 20, wherein the to-be-transmitted information comprises conflict information, and the conflict information indicates a resource on which conflict exists in an allocated or reserved resource.

22. The method of claim 20, wherein the to-be-transmitted information comprises a resource set, and the resource set comprises one or more of the following:
New Radio (NR) candidate resource set;
NR unavailable resource set, wherein the NR unavailable resource set is a set of resources that are reserved for sidelink (SL) of Long-Term Evolution (LTE) or are unavailable to the user equipment for a capability reason; or
an available resource set, wherein the available resource set is a candidate resource set acquired by the user equipment through an LTE perception process.

23. The method of claim 22, wherein the NR candidate resource set comprises one or more of the following:
a first candidate resource set acquired by the user equipment (UE) through an NR perception process; or
a second candidate resource set.

24. The method of claim 23, wherein the second candidate resource set comprises one or more of the following:
a set acquired by excluding, in the NR perception process, resources overlapping with the NR unavailable resource set;
an intersection of the candidate resource set acquired in the NR perception process and the available resource set;
a set acquired by excluding, through the NR perception process, unavailable resources from a first initial set, wherein the available resource set is used as the first initial set; and
a set acquired by excluding, through the NR perception process, unavailable resources from a second initial set, wherein an intersection of a set of all candidate resources determined according to a resource selection window and the available resource set is used as the second initial set;
wherein the unavailable resources comprise one or more of the following: all possible reserved resources on an unmonitored slot; resources overlapping with resources reserved by sidelink control information corresponding to SL transmission whose reference signal received power (RSRP) measured in a monitored time slot is greater than a first RSRP threshold; or
resources overlapping with the NR unavailable resource set.

25. The method of claim 20, further comprising: receiving one or more of the following:
a resource pool corresponding to a resource set;
a bandwidth part corresponding to a resource set;
a start position of a time window of a resource set;
a reference time slot of resources in a resource set;
a time-frequency position of resources in a resource set;
a resource set type;
a re-evaluated resource; or
a re-preempted resource.

26. A user equipment, comprising a memory, a processor, and a computer program stored in the memory and executable by the processor, wherein when executing the computer program, the processor performs the following steps:
determining to-be-transmitted information, wherein the to-be-transmitted information indicates that a management entity selects a resource for the user equipment; and
transmitting the to-be-transmitted information to the management entity.

27. A management entity, comprising a memory, a processor,
and a computer program stored in the memory and executable by the processor, wherein when executing the computer program, the processor performs the method of claim 20.

28. A non-transitory storage medium storing a computer program that, when executed by a processor, causes the processor to perform the method of claim 1.
